(19) United States
(12) Patent Application Publication
(10) Pub. No.: US 2026/0164330 A1
(43) Pub. Date: Jun. 11, 2026

(54) METHODS FOR LOCAL WIRELESS TRANSMIT/RECEIVE UNIT (WTRU)-TO-WTRU RELAY SOFT RESELECTION

(71) Applicant: InterDigital Patent Holdings, Inc., Wilmington, DE (US)

(72) Inventors: Joe Huang, Montville, NJ (US); Jung Je Son, Warrington, PA (US); Sudhir Pattar, Mount Laurel, NJ (US); Kyle Jung-Lin Pan, Saint James, NY (US); Phillip Leithead, King of Prussia, PA (US)

(73) Assignee: InterDigital Patent Holdings, Inc., Wilmington, DE (US)

(21) Appl. No.: 18/963,477

(22) Filed: Nov. 27, 2024

(51) Int. Cl. H04W 36/30; H04L 5/00; H04W 36/08

(52) U.S. Cl. CPC H04W 36/30; H04L 5/0053; H04W 36/08

(57) ABSTRACT

Methods, apparatuses, devices, and procedures for local wireless transmit/receive unit (WTRU)-to-WTRU relay soft reselection are provided. A WTRU detects degradation in a first link with a first relay WTRU. The WTRU identifies one or more candidate relay WTRUs. The WTRU transmits a first link modification request (LMR) message to the first relay WTRU. The first LMR message is indicative of at least one of: a relay reselection indication or one or more candidate relay WTRUs. The first relay WTRU establishes a second link with a candidate relay WTRU from the one or more candidate relay WTRUs. The WTRU receives a first link modification accept (LMA) message from the first relay WTRU. The first LMA message is indicative of at least one of: the relay reselection indication and/or an acknowledgement of establishment of the second link. The WTRU transmits a link modification notification (LMN) message to one or more downstream WTRUs.

### STATEMENT OF GOVERNMENT RIGHTS

This invention was made with Government support under Contract No. N00014-21-C-1080 awarded by the Office of Naval Research. The Government has certain rights in the invention.

### BACKGROUND

In wireless communication networks such as fifth generation (5G) networks, 5G proximity services (ProSe) and/or 5G device-to-device (D2D) applications may be used. In 5G ProSe and/or 5G D2D applications, one or more relay connections may be setup between multiple devices. In multi-hop relays, a source device may discover one or more remote end devices and communicate with the one or more remote end devices via various types of relay links. When two end devices are connected via multi-hop relay links in a relay mesh network, the two end devices may use another set of relay links when a link quality between an end device and a relay device or between two relay devices degrades. In such cases, triggering end-to-end relay reselection between every pair of the end devices causes excessive signal overhead and delays.

### SUMMARY

In various embodiments of the present disclosure, a wireless transmit/receive unit (WTRU) is provided. The WTRU includes a memory, a transceiver, and a processor. The transceiver and the processor are configured to detect degradation in a first link with a first relay WTRU. The transceiver and the processor are further configured to identify one or more candidate relay WTRUs. The transceiver and the processor are further configured to transmit a first link modification request (LMR) message to the first relay WTRU. The first LMR message is indicative of at least one of: a relay reselection indication or the one or more candidate relay WTRUs. The transceiver and the processor are further configured to establish a second link with a candidate relay WTRU from the one or more candidate relay WTRUS.

In an embodiment, the transceiver and the processor are further configured to receive a first link modification accept (LMA) message from the first relay WTRU. The first LMA message is indicative of at least one of: the relay reselection indication or an acknowledgement of establishment of the second link.

In an embodiment, establishing the second link comprises receiving a link establishment request (LER) message and/or a second LMR message from the candidate relay WTRU. The WTRU transmits a link establishment accept (LEA) message based on the LER message and/or transmits a second LMA message based on the second LMR message.

In an embodiment, the first link connects to one or more downstream end WTRUs via the first relay WTRU.

In an embodiment, the transceiver and the processor are further configured to transmit a link modification notification (LMN) message to the one or more downstream end WTRUs. The LMN message is indicative of establishment of the second link.

In an embodiment, the transceiver and the processor are further configured to: dynamically update, in a unicast routing table in the memory, one or more routes associated with one or more of: the one or more downstream end WTRUs or the one or more candidate relay WTRUs.

In an embodiment, the first LMR message is further indicative of one or more of: one or more identities of the one or more downstream end WTRUs routable via the first relay WTRU or a quality of service (QoS) information set associated with one or more downstream peer end WTRUs of the WTRU.

In various embodiments, a method for use in a WTRU is provided, the method comprises detecting degradation in a first link with a first relay WTRU. The method further comprises identifying one or more candidate relay WTRUs. The method further comprises transmitting a first LMR message to the first relay WTRU. The first LMR message is indicative of at least one of: a relay reselection indication or the one or more candidate relay WTRUs. The method further comprises establishing a second link with a candidate relay WTRU from the one or more candidate relay WTRUs.

In various embodiments of the present disclosure, a WTRU is provided. The WTRU comprises a memory, a transceiver, and a processor. The transceiver and the processor are configured to receive, from a first relay WTRU, a first link modification request (LMR) message indicative of at least one of: a relay reselection indication or a plurality of candidate relay WTRUs accessible by a first end WTRU. The transceiver and the processor are further configured to discover one or more one or more candidate relay WTRUs from the plurality of candidate relay WTRUs. The transceiver and the processor are further configured to transmit, to a candidate relay WTRU from the one or more candidate relay WTRUs, a LER message and/or a second LMR message. The transceiver and the processor are further configured to receive, from the candidate relay WTRU, a LEA message based on the LER message and/or a second LMA message based on the second LMR message.

In an embodiment, at least one of: the LER message and/or the second LMR message is indicative of one or more of: an identifier of the first end WTRU or a QoS information set between the first end WTRU and the WTRU associated with one or more downstream peer end WTRUs of the first end WTRU routable via the first relay WTRU and the WTRU.

In an embodiment, the transceiver and the processor are further configured to transmit, to the first end WTRU, via the first relay WTRU, a first LMA message indicative of at least one of: the relay reselection indication or establishment of the communication link between the first end WTRU and the WTRU.

In an embodiment, the transceiver and the processor are further configured to receive a LMN message from the first end WTRU via the candidate relay WTRU. The transceiver and the processor are further configured to forward the LMN message to one or more downstream end WTRUs.

In an embodiment, the WTRU is an intermediate end WTRU functioning as an intermediate relay WTRU.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example configuration for a negotiated reselection between an initiating WTRU and a responding relay WTRU according to one or more embodiments;

FIG. 3 illustrates an example configuration for a soft reselection between an initiating end WTRU and a responding relay WTRU with a responding WTRU-to-WTRU (U2U) relay as a candidate U2U relay discoveree according to one or more embodiments;

FIG. 4 illustrates an example configuration for a soft reselection between an initiating U2U relay and an end WTRU with the initiating U2U relay as a candidate U2U relay discoveree according to one or more embodiments;

FIG. 5 illustrates an example configuration for a soft reselection between an initiating U2U relay and a responding U2U relay with the responding U2U relay as a candidate U2U relay discoveree according to one or more embodiments;

FIG. 6 illustrates an example configuration for a soft reselection between an initiating U2U relay and a responding U2U relay with the initiating U2U relay as a discoveree according to one or more embodiments;

FIG. 7 illustrates an example process for a negotiated reselection between an initiating end WTRU and a responding U2U relay according to one or more embodiments;

FIG. 8 is a flow diagram illustrating an example process for a soft reselection between an initiating end WTRU and a responding U2U relay with the responding U2U relay as a candidate U2U relay discoveree according to one or more embodiments;

FIG. 9 is a flow diagram illustrating an example process for a soft reselection between an initiating U2U relay and an end WTRU with the initiating U2U relay as a candidate U2U relay discoveree according to one or more embodiments;

FIG. 10 is a flow diagram illustrating an example process for a soft reselection between an initiating U2U relay and a responding U2U relay with the responding U2U relay as a candidate U2U relay discoveree according to one or more embodiments;

FIG. 11 is a flow diagram illustrating an example process for a soft reselection between an initiating U2U relay and a responding U2U relay with the initiating U2U relay as a candidate U2U relay discoveree according to one or more embodiments;

FIG. 12 is a flowchart illustrating an example process for a soft relay reselection according to one or more embodiments; and

FIG. 13 is a flowchart illustrating an example process for a soft relay reselection according to one or more embodiments.

### DETAILED DESCRIPTION

As discussed herein, one or more abbreviations in the following (non-exhaustive) list, shown in Table 1, may be used herein.

TABLE 1

| | |
|---|---|
| DCR | Direct Connection Request |
| DCA | Direct Connection Accept |
| LER | Link Establishment Request |
| LEA | Link Establishment Accept |
| LMR | Link Modification Request |
| LMA | Link Modification Accept |
| LMN | Link Modification Notification |
| RSC | Relay Service Code |
| U2N Relay | User Equipment (UE)/Wireless |
| | Transmit/Receive Unit (WTRU) to Network |
| | Relay |
| U2U Relay | UE/WTRU to UE/WTRU Relay |

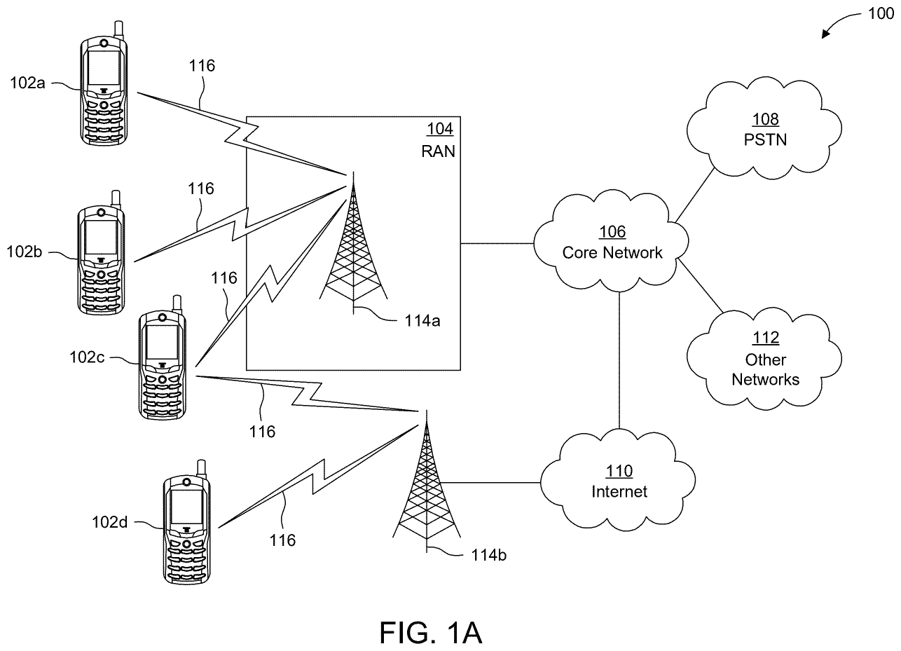

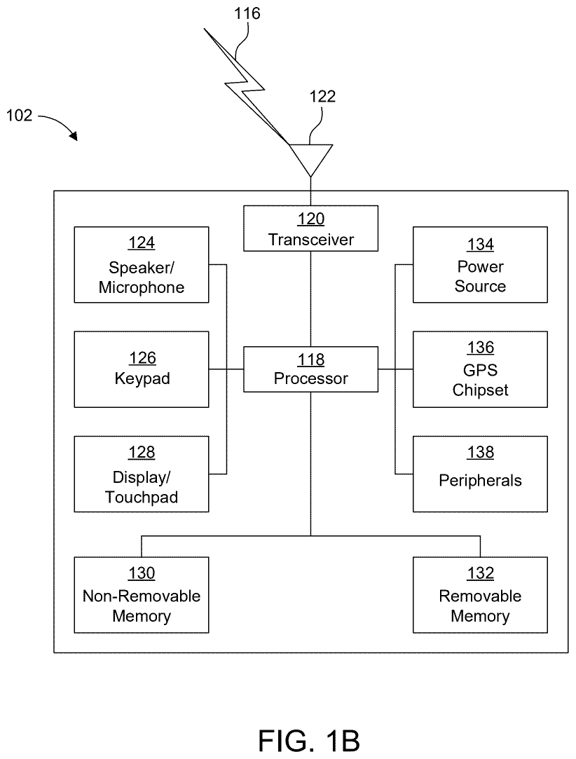

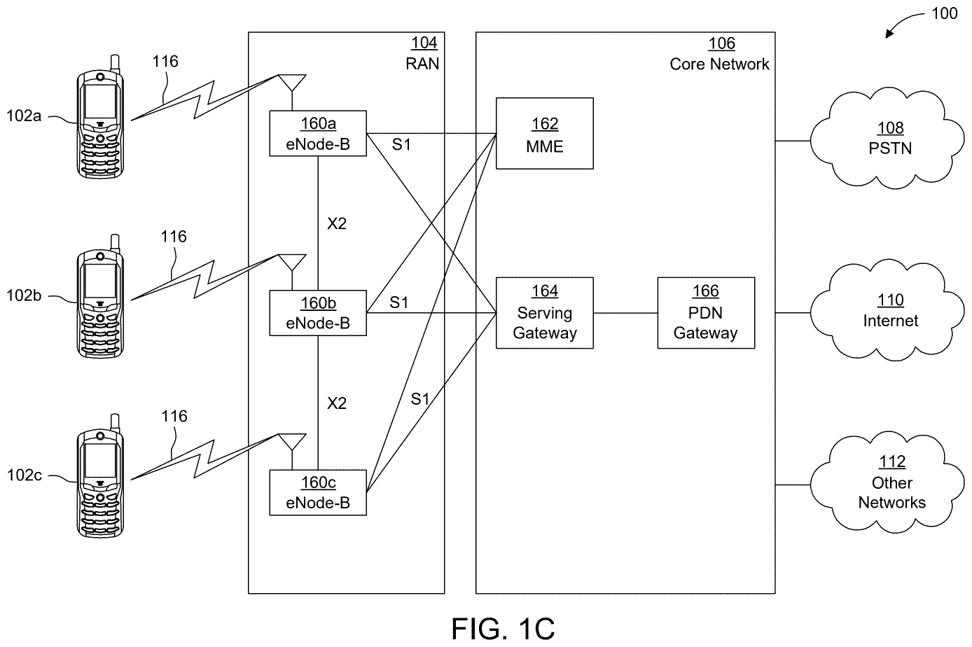

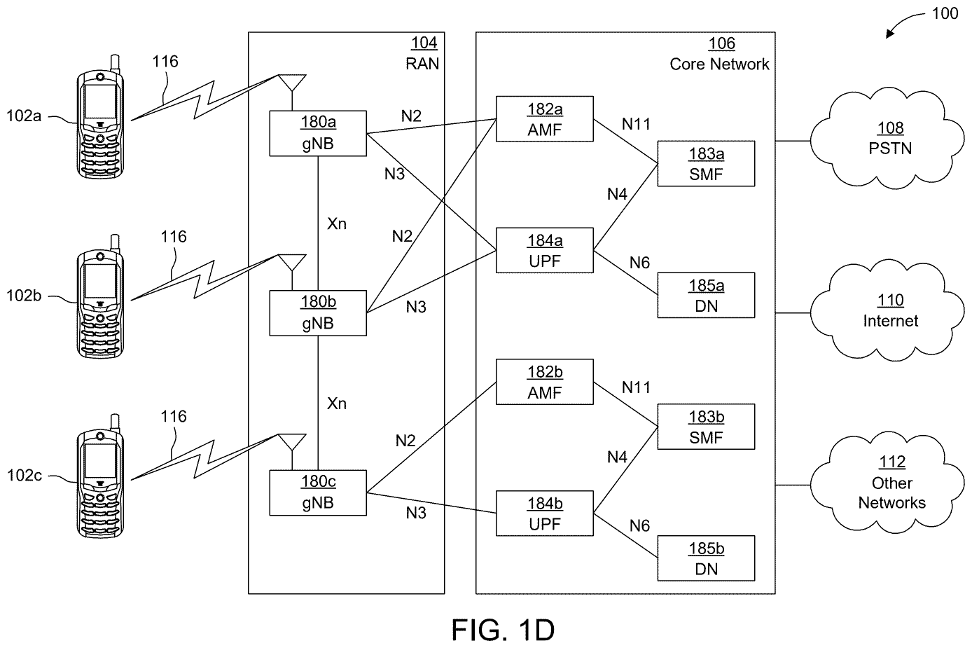

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In various embodiments of the present disclosure, one or more methods for local WTRU-to-WTRU (U2U) relay soft reselection are provided. In that, one or more methods for multi-hop U2U discovery and/or setup are provided. Further, one or more coordinated multi-hop U2U relay reselection procedures are provided. In an example, one or more relay methods used in fifth generation (5G) proximity services (ProSe) and/or 5G device-to-device (D2D) applications are provided.

In an embodiment, WTRU-to-WTRU relay discovery and PC5 setup is used. 5G ProSe provides several features and/or procedures such as 5G ProSe direct discovery and 5G ProSe direct communication, 5G ProSe WTRU-to-network (U2N) relay, and 5G ProSe WTRU-to-WTRU (U2U) relay. 5G ProSe WTRU-to-WTRU relay enables indirect communication between two end WTRUs. For WTRU-to-WTRU relay, 5G ProSe WTRU-to-WTRU relay discovery and 5G ProSe communication via WTRU-to-WTRU relay are provided.

For 5G ProSe WTRU-to-WTRU relay discovery, both model A and model B discovery are supported. Model A uses a single discovery protocol message (announcement). Model B uses two discovery protocol messages (solicitation and response). Further, discovery integrated into PC5 unicast link establishment procedure is also supported.

5G ProSe communication via WTRU-to-WTRU relay is possible with Layer 2 WTRU-to-WTRU relay and/or Layer 3 WTRU-to-WTRU relay. For Layer 2 WTRU-to-WTRU relay and/or Layer 3 WTRU-to-WTRU relay, 5G ProSe communication setup with discovery procedures is provided. Further, discovery integrated into PC5 unicast link establishment procedure is provided.

With Layer 2 WTRU-to-WTRU relay, an end-to-end PC5 link is established between the end WTRUs, via the relay. One or more PC5-S messages may be exchanged between the end WTRUs. With Layer 3 WTRU-to-WTRU relay, each end WTRU may establish a PC5 link with the relay and the relay may forward the messages to the end WTRUs. The one or more PC5-S messages may be exchanged between the end WTRUs and the relay.

With Layer 3 WTRU-to-WTRU relay, when an internet protocol (IP) based data connection is used, after PC5 link setup with the relay, each end WTRU may be assigned an IP address by the relay which may be based on a dynamic host configuration protocol (DHCP) mechanism or each end WTRU may assign its own IP address, which may be based on a link local IP address assignment mechanism, and may inform the IP address to the relay. Whether DHCP or link local IP address assignment is used, may be determined during security connection setup between the end WTRU and the WTRU-to-WTRU relay.

For WTRU-to-WTRU relay reselection, after the connection is setup between two end WTRUs via a WTRU-to-WTRU relay, each end WTRU may keep monitoring a channel status of the PC5 link and when a link quality goes below a threshold link quality, the end WTRU may select another WTRU-to-WTRU relay for the connection between the two end WTRUS.

For WTRU-to-WTRU relay reselection, one or more WTRU-to-WTRU relay discovery procedures may be used and/or a negotiated 5G ProSe WTRU-to-WTRU relay reselection procedure may be used.

In the negotiated WTRU-to-WTRU relay reselection, an end WTRU may initiate the WTRU-to-WTRU relay reselection procedure. The end WTRUs may negotiate a new WTRU-to-WTRU relay using an existing connection and establish the communication via the reselected WTRU-to-WTRU relay prior to releasing the communication via the current 5G ProSe WTRU-to-WTRU relay.

In multi-hop WTRU-to-network and WTRU-to-WTRU relay, the multi-hop WTRU-to-network relay may enable a remote WTRU to discover and communicate with a U2N relay via one or more U2U relays. multi-hop WTRU-to-WTRU relay may also enable the end WTRUs to discover and communicate with each other via more than one U2U relay. The multi-hop capability may be deemed crucial for mission critical communications (e.g., first responders) and in general need to enhance coverage (e.g., indoor).

When two end WTRUs (e.g., WTRU-1 and WTRU-2) are connected via the multi-hop U2U relays in a WTRU-to-WTRU relay mesh network, the two end WTRUs may change to another set of U2U relays when the link quality between an end WTRU and a U2U relay and/or between two U2U relays is degraded. Therefore, a solution is needed to mitigate different link quality degradation scenarios. In general, there may be multiple pairs of the end WTRUs that are inter-connected via the degraded link. Although it is possible to trigger negotiated end-to-end (multi-hop) WTRU-to-WTRU relay reselection procedure between every pair of the end WTRUs, such an approach may not be efficient. To reduce signaling overhead, it would be beneficial to have a capability to first perform local WTRU-to-WTRU relay reselection before resorting to end-to-end WTRU-to-WTRU relay reselection. Therefore, there is a need to perform local WTRU-to-WTRU relay reselection associated with multiple pairs of the end WTRUs when the end WTRU and/or a U2U relay detects the link quality degradation with a neighbor U2U relay in a WTRU-to-WTRU relay mesh network.

In this disclosure, a WTRU-to-WTRU (U2U) relay may refer to a WTRU which may be authorized and/or which may behave as a relay WTRU to forward traffic between the end WTRUs. The multi-hop WTRU-to-WTRU relay discovery procedure may be performed by the end WTRU to discover a path to an announced WTRU (Model A) or a discoveree end WTRU (Model B) via one or more U2U relays. In addition, (multi-hop) candidate WTRU-to-WTRU relay discovery procedure may be performed by the end WTRU to discover end-to-end path to a target U2U relay via one or more U2U relays. The target U2U relay may be accessible by the peer end WTRU in a direct PC5 connection. In general, a candidate end WTRU that is not an intended discoveree end WTRU may also act as a U2U relay to provide connectivity for another end WTRUs. In this regard, (multi-hop) candidate WTRU-to-WTRU relay discovery procedure may also be performed by an end WTRU acting as a U2U relay to discover an end-to-end path to a target U2U relay.

A multi-hop WTRU-to-WTRU relay link establishment procedure is used to set up a PC5 connection over the end-to-end path. After (multi-hop) WTRU-to-WTRU relay discovery, the initiating end WTRU may establish connectivity and/or modify an existing PC5 link with a U2U relay, through a direct communication request (DCR) and/or a link modification request (LMR). The U2U relay may establish connectivity with the next U2U relay along the discovered path, through a DCR and/or a LMR. The process may continue until the target end WTRU is reached. The target end WTRU may transmit a direct communication accept (DCA) and/or a link modification accept (LMA) to a selected U2U relay that the target end WTRU receives the DCR and/or LMR from. Each U2U relay along the selected reverse path may transmit the DCA and/or the LMA hop by hop. The end-to-end connectivity between the initiating end WTRU and the target end WTRU is established when the DCA and/or LMA is received by the initiating end WTRU.

In a negotiated local WTRU-to-WTRU relay reselection, one end WTRU may initiate the WTRU-to-WTRU relay reselection procedure. The initiating end WTRU may negotiate a new U2U relay (accessible by the initiating end WTRU-to-WTRU in the direct PC5 connection) with a responding intermediate end WTRU acting as a U2U relay and may establish an alternative local (multi-hop) connection via the newly selected U2U relay.

In a local WTRU-to-WTRU relay soft reselection, an end WTRU or a U2U relay may establish a (multi-hop) connection with another end WTRU or U2U relay via one or more reselected U2U relays prior to releasing the existing connection via one or more current U2U relays. The negotiated local WTRU-to-WTRU relay reselection may be viewed as an example approach of local WTRU-to-WTRU relay soft reselection.

The link establishment request (LER) and/or link establishment accept (LEA) messages may be used for setting up the one or more PC5 connections for WTRU-to-WTRU relay communication, similar to the direct communication request (DCR) and/or the direct communication accept (DCA) messages. For DCR and/or DCA, both the source WTRU and the target WTRU may be the end WTRUs. On the other hand, for LER and/or LEA, either the source WTRU or the target WTRU (or both) may be a U2U relay (or U2U relays).

Upon the completion of the local WTRU-to-WTRU relay reselection and the corresponding link establishments to repair a portion of the end-to-end path, a U2U relay or an end WTRU may transmit a link modification notification (LMN) message to one or more end WTRUs to facilitate one or more unicast routing table updates along the end-to-end path and any follow-up Layer 3 or Layer 2 end-to-end connection and/or configuration updates, as needed.

The unicast routing table (per relay service code) may be used in the PC5 singling plane (PC5-S) and may be set up during a link establishment procedure. Upon the reception of a LMR message and/or in a security procedure after receiving a DCR message, the U2U relay or the end WTRU may add an entry to the unicast routing table to the source end WTRU, with a destination set to user information identifier (ID) of the source end WTRU, and next-hop user information ID and/or a Layer 2 ID set to a sender user information ID and/or a source Layer 2 ID of the received message. Upon the reception of the DCA message and/or the LMA message, a U2U relay or an end WTRU may add an entry to the unicast routing table to the target end WTRU, with destination set to user info ID of the target end WTRU and next-hop user information ID and/or Layer 2 ID set to the sender user information ID and/or source layer 2 ID of the received message.

In a quality of service (QoS) context of the unicast routing table for each destination end WTRU in the unicast routing table of a U2U relay, the QoS context may be recorded. The QoS context may include, for the destination end WTRU being the source end WTRU during end-to-end link establishment, a list of peer target end WTRUs associated with the destination end WTRU being the source end WTRU, a list of QoS information between the current U2U relay and each target end WTRU. For destination end WTRU being the target end WTRU during end-to-end link establishment, a list of peer source end WTRUs associated with the destination end WTRU being the target end WTRU and a list of QoS information between the current U2U relay and the destination end WTRU associated with each peer source end WTRU.

In an embodiment, a wireless communication system may include a plurality of devices, including but not limited to one or more relay devices, one or more end devices, and/or one or more intermediate end devices. In an example, the relay devices, end devices, and/or the intermediate end devices may include but are not limited to WTRUs, 5G WTRUS, such as 5G ProSe enabled WTRUs etc. A first relay device may detect a link quality degradation for a first link between the first relay device and a second relay device. The first relay device may generate and transmit a link modification request (LMR) message with a relay reselection indication, via the second relay device, to a first intermediate end device. The first intermediate end device may function as a relay device to connect with one or more downstream devices. The first intermediate end device may perform a U2U relay discovery to find and/or determine an alternative route to the first relay device. Upon discovery, the first intermediate end device may select a third relay device to as the alternative route to connect to the first relay device. The first intermediate device may setup and/or modify a second link (e.g. a direct communication link such as PC5 link etc.) along the alternative route to the first relay device. The first intermediate device may generate and transmit a link modification accept (LMA) message with the relay reselection indication to the first relay device via the second relay device. The first relay device may generate and transmit a link modification notification (LMN) message to notify the one or more downstream devices and/or one or more upstream devices. In an example, the one or more upstream devices and/or the one or more downstream devices may include the one or more end devices and/or the one or more intermediate end devices that may be previously routed through the first link.

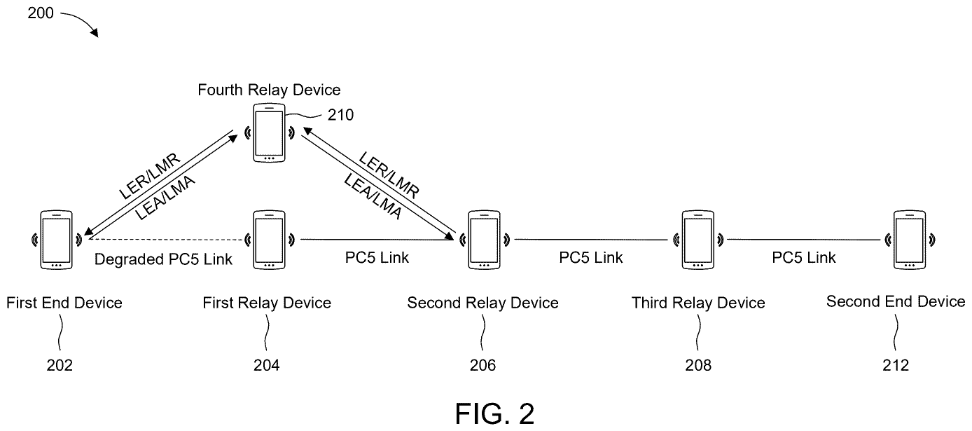

Referring now to FIG. 2, a communication system 200 illustrating an example configuration for a negotiated reselection between an initiating WTRU and a responding relay WTRU is shown according to one or more embodiments. The communication system 200 may include a first end device 202, a first relay device 204, a second relay device 206, a third relay device 208, and a fourth relay device 210, and a second end device 212. Examples of the first end device 202, the first relay device 204, the second relay device 206, the third relay device 208, and the fourth relay device 210, and the second end device 212 include but are not limited to one or more WTRUs, 5G ProSe enabled WTRUs, and/or D2D enabled WTRUs etc. Further, the first end device 202, the first relay device 204, the second relay device 206, the third relay device 208, and the fourth relay device 210, and the second end device 212 may include but are not limited to one or more devices in vehicles and/or carried by pedestrians, one or more network devices and/or infrastructure devices etc.

The first end device 202 may detect a link quality degradation of a first link between the first end device 202 and the first relay device 204. The first end device 202 may generate and transmit a LMR message with a relay reselection indication, via the first relay device 204, to the second relay device 206 acting as a U2U relay after passing the degraded link, i.e., the first link (e.g. the second relay device 206), including a list of candidate U2U relays. The second relay device 206 may perform candidate U2U relay discovery and select a U2U relay received from the first end device 202 to determine an alternative route to the first end device 202 (here, via the fourth relay device 210). The second relay device 206 may set up and/or modify one or more PC5 connections, e.g. a second link, along a newly selected route to the first end device 202. The second relay device 206 may generate and transmit a LMA message with the relay reselection indication to the first end device 202, via the first relay device 204. The first end device 202 may generate and transmit a LMN message to notify one or more peer end devices originally routed through the degraded link, i.e., the first link (here, the second end device 212). Examples of the first link and/or the second link may include but are not limited to vehicle-to-vehicle (V2V) links, vehicle-to-infrastructure (V2I) links, vehicle to pedestrian (V2P) links and/or vehicle-to-everything (V2X) links etc.

The first end device 202 may function as detecting and/or initiating end device. The first end device 202 may detect the link quality degradation between the first end device 202 and the first relay device 204. The first end device 202 may obtain and/or select a list of candidate U2U relays accessible by first end device 202 in one or more direct PC5 connections. The first end device 202 may transmit the LMR message with the relay reselection indication to the first relay device 204, which may include information of the list of one or more candidate U2U relays (here, the fourth relay device 210), information of the first end device 202 and a list of identified peer end devices originally routed through the degraded link, i.e. the first link (here, the second end device 212), end-to-end quality of service (QoS) information set for the first end device 202 and the one or more peer end devices (here, the second end device 212) in communication with the first end device 202. The first end device may receive a link establishment request (LER) message and/or the LMR message from the fourth relay device 210, which may include information of the first end device 202 and the list of identified peer end devices (here, the second end device 212). The first end device 202 may transmit the LEA message and/or the LMA message to the fourth relay device 210, which may include the QoS information set between the fourth relay device 210 and the first end device 202, associated with the one or more peer end devices (here, the second end device 212). The first end device 202 may possibly request an internet protocol (IP) address from the fourth relay device 210. The first end device 202 may receive the LMA message with the relay reselection indication originated from the second relay device 206, via the first relay device 204. The first end device 202 may transmit the LMN message to the list of identified peer end devices (here, the second end device 212, via the fourth relay device 210). The first end device 202 may exchange traffic with the second end device 212 via the newly selected route between the first end device 202 and the second end device 212.

The first relay device 204 may be the degraded link or a degraded peer U2U relay device. The first relay device 204 may receive the LMR message with the relay reselection indication from the first end device 202, which may include information of the first end device 202 and the list of identified peer end devices originally routed through the degraded link (here, the second end device 212). The first relay device 204 may transmit the LMR message with the relay reselection indication to the second relay device 206, which may include information of the list of candidate U2U relays (here, the fourth relay device 210) received from the first end device 202, information of the first end device 202 and a sub-list of the peer end devices (here, the second end device 212) that are routable by the first relay device 204 via the second relay device 206, end-to-end QoS information set for the first end device 202 and the identified peer end devices (here, the second end device 212). The first relay device 204 may receive the LMA message with the relay reselection indication from the second relay device 206, which may include information of the first end device 202 and the list of identified peer end devices. The first relay device 204 may transmit the LMA message with the relay reselection indication to the first end device 202, which may include information of the first end device 202 and the list of identified peer end devices.

The second relay device 206 may function as a responder and/or a discoverer end device serving as a U2U relay. The second relay device 206 may receive the LMR message with the relay reselection indication from the first relay device 204, which may include information of the first end device 202 and the list of identified peer end devices (here, the second end device 212). The second relay device 206 may determine the QoS information set between the second relay device 206 and the first end device 202, associated with the identified peer end devices (here, the second end device 212). The second relay device 206 may perform candidate U2U relay discovery to select the U2U relay (here, the fourth relay device 210) among the received candidate U2U relays in the LMR with the relay reselection indication, along with the discovered route. The second relay device 206 may transmit the LER message and/or the LMR message to the fourth relay device 210, which may include information of the first end device 202 and the list of identified peer end devices (here, the second end device 212). The second relay device 206 may respond to security establishment with the fourth relay device 210 after LER. The second relay device 206 may provide the QoS information set between the second relay device 206 and the first end device 202, associated with the identified peer end devices (here, the second end device 212), to the fourth relay device 210, in the security procedure after the LER message and/or in the LMR message. The second relay device 206 may receive the LEA message and/or the LMA message from the fourth relay device 210, which may include information of the first end device 202 and the list of identified peer end devices (here, the second end device 212). The second relay device 206 may transmit the LMA message with the relay reselection indication to the first end device 202, via the first relay device 204, which may include information of the first end device 202 and the list of identified peer end devices (here, the second end device 212). The second relay device 206 may receive the LMN message originating from the first end device 202, via the fourth relay device 210. The second relay device 206 may transmit the LMN message to the list of identified peer end devices (here, the second end device 212, via the third relay device 208).

The third relay device 208 may function as the U2U relay. The third relay device may receive the LMN message originating from the first end device 202, via the second relay device 206. The third relay device 208 may transmit the LMN message to the list of identified peer end devices (here, the second end device 212).

The fourth relay device 210 may be a candidate U2U relay. The fourth relay device 210 may determine the QoS information set between the second relay device 206 and the fourth relay device 210 and the QoS information set between the fourth relay device 210 and the first end device 202 based on the QoS information set between the second relay device 206 and the first end device 202 received from the second relay device 206 for the first end device 202 and the identified peer end devices (here, the second end device 212). The fourth relay device 210 may receive the LER message and/or the LMR message from the second relay device 206, which may include information of the first end device 202 and the list of identified peer end devices (here, the second end device 212). The fourth relay device 210 may transmit the LER message and/or the LMR message to the first end device 202, which may include information of the first end device 202 and the list of identified peer end devices (here, the second end device 212). The fourth relay device 210 may respond to the security establishment with the first end device 202 after the LER message. The fourth relay device 210 may provide the QoS information set between the fourth relay device 210 and the first end device 202, associated with the identified peer end devices (here, the second end device 212), to the first end device 202, in the security procedure after the LER message and/or in the LMR message. The fourth relay device 210 may receive the LEA message and/or the LMA message from the first end device 202, which may include information of the first end device 202 and the list of identified peer end devices (here, the second end device 212). The fourth relay device 210 may transmit the LEA message and/or the LMA message to the second relay device 206, which may include the QoS information set between the second relay device 206 and the fourth relay device 210, for the first end device 202 and the identified peer end devices (here, the second end device 212). The fourth relay device 210 may receive the LMN message from the first end device 202. The fourth relay device 210 may transmit the LMN message to the list of identified peer end devices (here, the second end device 212, via the second relay device 206).

The second end device 212 may function as the peer end device. The second end device 212 may receive the LMN message originated from the first end device 202, via the third relay device 208. The second end device 212 may exchange traffic with the first end device 202 via the newly selected route between the first end device 202 and the second end device 212.

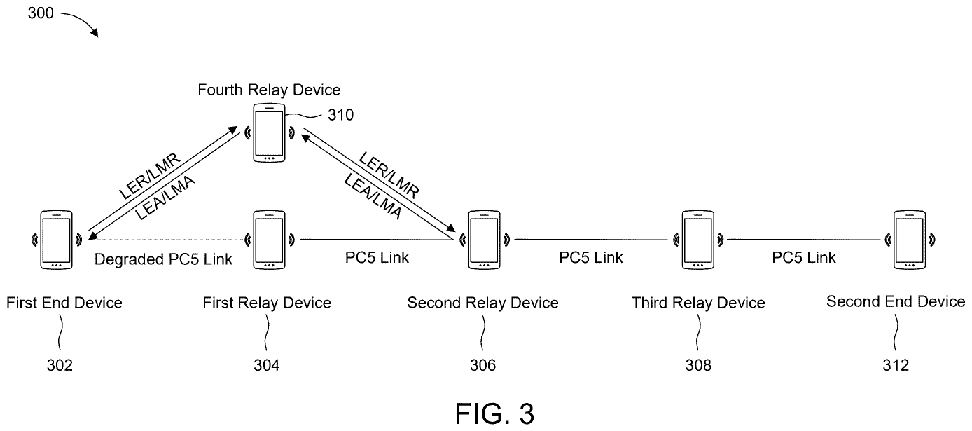

Referring now to FIG. 3, a communication system 300 illustrating an example configuration for a soft reselection between an initiating end WTRU and a responding relay WTRU with a responding U2U relay as a candidate U2U relay discoveree is shown according to one or more embodiments. The communication system 300 may include a first end device 302, a first relay device 304, a second relay device 306, a third relay device 308, and a fourth relay device 310, and a second end device 312. Examples of the first end device 302, the first relay device 304, the second relay device 306, the third relay device 308, and the fourth relay device 310, and the second end device 312 include but are not limited to one or more WTRUs, 5G ProSe enabled WTRUs, and/or D2D enabled WTRUs etc. Further, the first end device 302, the first relay device 304, the second relay device 306, the third relay device 308, and the fourth relay device 310, and the second end device 312 may include but are not limited to one or more devices in vehicles and/or carried by pedestrians, one or more network devices and/or infrastructure devices etc.

The first end device 302 may detect a link quality degradation on a first link between the first end device 302 and the first relay device 304. The first end device 302 may transmit a LMR message with a relay reselection indication to the first relay device 304. The first relay device 304 may transmit the LMR message with the relay reselection indication to one or more next hops of the first end device 302 that are associated with one or more peer end devices (here, second relay device 306). The second relay device 306 may transmit a LMA message with the relay reselection indication to the first end device 302, via the first relay device 304. The first end device 302 may perform a candidate U2U relay discovery to determine an alternative route to the second relay device 306 (here, a second link via the fourth relay device 310). The first end device 302 may set up and/or modify one or more PC5 connections along the newly selected route to the second relay device 306. The first end device 302 may transmit a LMN message to notify the one or more peer end devices originally routed through the degraded link (here, the second end device 312).

The first end device 302 may function as detecting, initiating, and discoverer end device. The first end device 302 may detect the link quality degradation between the first end device 302 and the first relay device 304. The first end device 302 may transmit the LMR message with the relay reselection indication to the first relay device 304, which may include information of the first end device 302 and the list of identified peer end devices originally routed through the degraded link (here, the second end device 312), end-to-end QoS information set for the first end device 302 and the identified peer end devices (here, the second end device 312). The first end device 302 may receive the LMA message with the relay reselection indication originated from the second relay device 306, via the first relay device 304, which may include information of the first end device 302 and the list of identified peer end devices (here, the second end device 312). The first end device 302 may perform a candidate U2U relay discovery to find and/or determine an alternative route to the second relay device 306 (here, via the fourth relay device 310). The first end device 302 may transmit the LER message and/or the LMR message to the fourth relay device 310, which may include information of the first end device 302 and the list of identified peer end devices (here, the second end device 312). The first end device 302 may respond to the security establishment with the fourth relay device 310 after the LER message. The first end device 302 may provide the QoS information set between the first end device 302 and the second relay device 306 received in the LMA message with the relay reselection indication originated from the second relay device 306, associated with the identified peer end devices (here, the second end device 312), to the fourth relay device 310, in the security procedure after the LER message and/or in the LMR message. The first end device 302 may receive the LEA message and/or the LMA message from the fourth relay device 310, which may include information of the first end device 302 and the list of identified peer end devices (here, the second end device 312). The first end device 302 may possibly request an IP address from the fourth relay device 310. The first end device 302 may transmit a LMN message to the list of identified peer end devices (here, the second end device 312, via the fourth relay device 310). The first end device 302 may exchange traffic with the second end device 312 via the newly selected route between the first end device 302 and the second end device 312.

The first relay device 304 may be the degraded link peer U2U relay. The first relay device 304 may receive the LMR message with the relay reselection indication from the first end device 302, which may include information of the first end device 302 and the list of identified peer end devices originally routed through the degraded link (here, the second end device 312). The first relay device 304 may transmit the LMR message with the relay reselection indication to the second relay device 306, which may include information of the first end device 302 and a sub-list of received peer end devices (here, the second end device 312) that are routable by the first relay device 304 via the second relay device 306, end-to-end QoS information set for the first end device 302 and the identified peer end devices (here, the second end device 312) received from the first end device 302. The first relay device 304 may receive the LMA message with the relay reselection indication from the second relay device 306, which may include information of the first end device 302 and the list of identified peer end devices. The first relay device 304 may transmit the LMA message with the relay reselection indication to the first end device 302, which may include information of the first end device 302 and the list of identified peer end devices.

The second relay device 306 may function as the responding and/or discoveree U2U relay. The second relay device 306 may receive the LMR message with the relay reselection indication originated from the first end device 302, via the first relay device 304, which may include information of the first end device 302 and the list of identified peer end devices. The second relay device 306 may determine the QoS information set between the first end device 302 and the second relay device 306 associated with the identified peer end devices (here, the second end device 312). The second relay device 306 may transmit the LMA message with the relay reselection indication to the first end device 302, via the first relay device 304, which may include information of the first end device 302 and the list of identified peer end devices (here, the second end device 312), the QoS information set between the first end device 302 and the second relay device 306, associated with the identified peer end devices (here, the second end device 312). The second relay device 306 may receive the LER message and/or the LMR message from the fourth relay device 310, which may include information of the first end device 302 and the list of identified peer end devices (here, the second end device 312). The second relay device 306 may establish security with the fourth relay device 310 if the PC5 connection between the second relay device 306 and the fourth relay device 310 has not been established. The second relay device 306 may transmit the LEA message and/or the LMA message to the fourth relay device 310, which may include information of the first end device 302 and the list of identified peer end devices (here, the second end device 312), the QoS information set between the fourth relay device 310 and the second relay device 306, for the first end device 302 and the identified peer end devices (here, the second end device 312). The second relay device 306 may receive the LMN message originated from the first end device 302, via the fourth relay device 310. The second relay device 306 may transmit the LMN message to the list of identified peer end devices (here, the second end device 312, via the third relay device 308).

The third relay device 308 may function as the U2U relay. The third relay device 308 may receive the LMN message originated from the first end device 302, via the second relay device 306. The third relay device 308 may transmit the LMN message to the list of identified peer end devices (here, the second end device 312).

The fourth relay device 310 may function as the alternative U2U relay. The fourth relay device 310 may receive the LER message and/or the LMR message from the first end device 302, which may include information of the first end device 302 and the list of identified peer end devices (here, the second end device 312). The fourth relay device 310 may establish security with the first end device 302 if the PC5 connection between the fourth relay device 310 and the first end device 302 has not been established. The fourth relay device 310 may determine the QoS information set between the first end device 302 and the fourth relay device 310 and the QoS information set between the fourth relay device 310 and the second relay device 306 based on the QoS information set between the first end device 302 and the second relay device 306 received from the first end device 302, for the first end device 302 and the identified peer end devices (here, the second end device 312), in the security procedure after the LER message and/or in the LMR message. The fourth relay device 310 may transmit the LER message and/or the LMR message to the second relay device 306, which may include information of the first end device 302 and the list of identified peer end devices (here, the second end device 312). The fourth relay device 310 may respond to the security establishment with the second relay device 306 after the LER message. The fourth relay device 310 may provide the QoS information set between the fourth relay device 310 and the second relay device 306 to the second relay device 306, for the first end device 302 and the identified peer end devices (here, the second end device 312) in the security procedure after the LER message and/or in the LMR message. The fourth relay device 310 may receive the LEA message and/or the LMA message from the second relay device 306, which may include information of the first end device 302 and the list of identified peer end devices (here, the second end device 312). The fourth relay device 310 may transmit the LEA message and/or the LMA message to the first end device 302, which may include information of the first end device 302 and the list of identified peer end devices (here, the second end device 312), the QoS information set between the first end device 302 and the fourth relay device 310 associated with the identified peer end devices (here, the second end device 312). The fourth relay device 310 may receive the LMN message from the first end device 302. The fourth relay device 310 may transmit the LMN message to the list of identified peer end devices (here, the second end device 312, via the second relay device 306).

The second end device 312 may be a peer end device. The second end device 312 may receive the LMN message originated from the first end device 302, via the third relay device 308. The second end device 312 may exchange traffic with the first end device 302 via the newly selected route between the first end device 302 and the second end device 312.

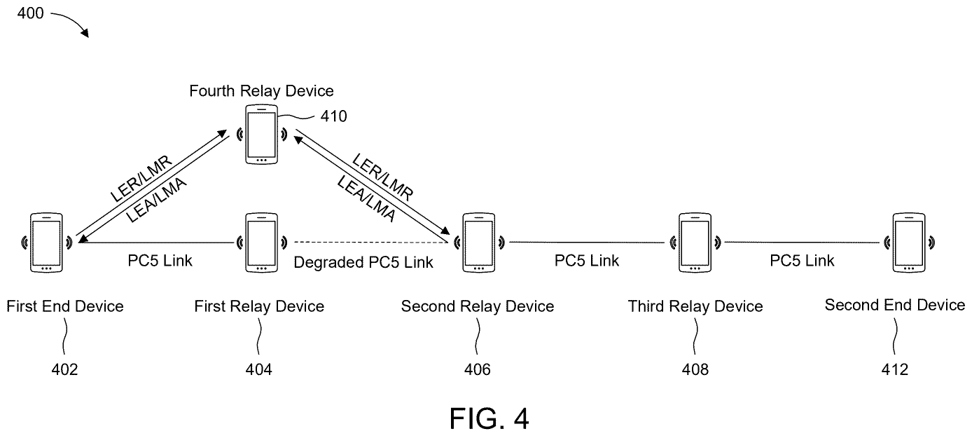

Referring now to FIG. 4, a communication system 400 illustrating an example configuration for a soft reselection between an initiating U2U relay and an end WTRU with the initiating U2U relay as a candidate U2U relay discoveree is shown according to one or more embodiments. The communication system 400 may include a first end device 402, a first relay device 404, a second relay device 406, a third relay device 408, and a fourth relay device 410, and a second end device 412. Examples of the first end device 402, the first relay device 404, the second relay device 406, the third relay device 408, and the fourth relay device 410, and the second end device 412 include but are not limited to one or more WTRUs, 5G ProSe enabled WTRUs, and/or D2D enabled WTRUs etc. Further, the first end device 402, the first relay device 404, the second relay device 406, the third relay device 408, and the fourth relay device 410, and the second end device 412 may include but are not limited to one or more devices in vehicles and/or carried by pedestrians, one or more network devices and/or infrastructure devices etc.

The second relay device 406 may detect a link quality degradation between the second relay device 406 and the first relay device 404. The second relay device 406 may transmit a LMR message with a relay reselection indication, via the first relay device 404, to one or more upstream end devices routed from the degraded link (here, the first end device 402). The first end device 402 may perform a candidate U2U relay discovery to find and/or determine an alternative route to the second relay device 406 (here, the fourth relay device 410). The first end device 402 may set up and/or modify one or more PC5 connections along the newly selected route to the second relay device 406. The first end device 402 may transmit the LMA message with the relay reselection indication to the second relay device 406, via the first relay device 404. The first end device 402 may transmit a LMN message to notify one or more peer end devices originally routed through the degraded link (here, the second end device 412).

The first end device 402 may be a responding device and/or a discoverer end device. The first end device 402 may receive the LMR message with the relay reselection indication originated from the second relay device 406, via the first relay device 404, which may include information of the first end device 402 and a list of one or more identified downstream end devices (here, the second end device 412). The first end device 402 may determine the QoS information set between the first end device 402 and the second relay device 406 associated with the identified peer end devices (here, the second end device 412). The first end device 402 may perform a candidate U2U relay discovery to find and/or determine the alternative route to the second relay device 406 (here, via the fourth relay device 410). The first end device 402 may transmit the LER message and/or the LMR message to the fourth relay device 410, which may include information of the first end device 402 and the list of identified peer end devices that are in the list of identified downstream end devices (here, the second end device 412). The first end device 402 may respond to the security establishment with the fourth relay device 410 after the LER message. The first end device 402 may provide the QoS information set between the first end device 402 and the second relay device 406 to the fourth relay device 410, associated with the identified peer end devices (here, the second end device 412) in the security procedure after the LER message and/or in the LMR message. The first end device 402 may receive the LEA message and/or the LMA message from the fourth relay device 410, which may include information of the first end device 402 and the list of the identified peer end devices (here, the second end device 412). The first end device 402 may request an IP address from the fourth relay device 410. The first end device 402 may transmit the LMA message with the relay reselection indication to the second relay device 406, via the first relay device 404. The first end device 402 may transmit the LMN message to the list of identified peer end devices (here, the second end device 412, via the fourth relay device 410). The first end device 402 may exchange the traffic with the second end device 412 via the newly selected route between the first end device 402 and the second end device 412.

The first relay device 404 may be the degraded link peer U2U relay. The first relay device 404 may receive the LMR message with the relay reselection indication from the second relay device 406, which may include information of the list of identified upstream end devices originally routed through the degraded link (here, the first end device 402). The first relay device 404 may transmit the LMR message with the relay reselection indication to the identified upstream end devices (here, the first end device 402), which may include information of the list of identified upstream end devices received from the second relay device 406 (here, the first end device 402) and the list of downstream end devices originally routed through the degraded link (here, the second end device 412), the QoS information set for each identified upstream end device (here, the first end device 402) and the identified downstream peer end devices (here, the first end device 402). The first relay device 404 may receive the LMA message with the relay reselection indication from the first end device 402, which may include information of the first end device 402 and the list of identified peer end devices. The first relay device 404 may transmit the LMA message with the relay reselection indication to the second relay device 406, which may include information of the first end device 402 and the list of identified peer end devices.

The second relay device 406 may function as detecting, initiating, and/or discoveree U2U relay. The second relay device 406 may detect the link quality degradation between the first relay device 404 and the second relay device 406. The second relay device 406 may transmit the LMR message with the relay reselection indication to the first relay device 404, which may include information of the list of identified upstream end devices originally routed through the degraded link (here, the first end device 402), the list of the QoS information sets of the second relay device 406 for the identified upstream end devices (here, the first end device 402) and the identified downstream peer end devices (here, the first end device 402). The second relay device 406 may receive the LER message and/or the LMR message from the fourth relay device 410, which may include information of the first end device 402 and the list of the identified peer end devices (here, the second end device 412). The second relay device 406 may establish security with the fourth relay device 410 if the PC5 connection between the second relay device 406 and the fourth relay device 410 has not been established. The second relay device 406 may transmit the LEA message and/or the LMA message to the fourth relay device 410, which may include information of the first end device 402 and the list of the identified peer end devices (here, the second end device 412), the QoS information set between the fourth relay device 410 and the second relay device 406, for the first end device 402 and the list of the identified peer end devices (here, the second end device 412). The second relay device 406 may receive the LMA message with the relay reselection indication originated from the first end device 402, via the first relay device 404, which may include information of the first end device 402 and the list of the identified peer end devices (here, the second end device 412). The second relay device 406 may receive the LMN message originated from the first end device 402, via the fourth relay device 410. The second relay device 406 may transmit the LMN message to the list of identified peer end devices (here, the second end device 412, via the third relay device 408).

The third relay device 408 may function as the U2U relay. The third relay device 408 may receive the LMN message originated from the first end device 402, via the second relay device 406. The third relay device 408 may transmit the LMN message to the list of identified peer end devices (here, the second end device 412).

The fourth relay device 410 may function as the alternative U2U relay. The fourth relay device 410 may receive the LER message and/or the LMR message from the first end device 402, which may include information of the first end device 402 and the list of the identified peer end devices (here, the second end device 412). The fourth relay device 410 may establish security with the first end device 402 if the PC5 connection between the fourth relay device 410 and the first end device 402 has not been established. The fourth relay device 410 may determine the QoS information set between the first end device 402 and the fourth relay device 410 and the QoS information set between the fourth relay device 410 and the second relay device 406 based on the QoS information set between the first end device 402 and the second relay device 406 received from the first end device 402, for the first end device 402 and the identified peer end devices (here, the second end device 412), in the security procedure after the LER message and/or in the LMR message. The fourth relay device 410 may transmit the LER message and/or the LMR message to the second relay device 406, which may include information of the first end device 402 and the list of the identified peer end devices (here, the second end device 412). The fourth relay device 410 may respond to the security establishment with the second relay device 406 after the LER message. The fourth relay device 410 may provide the QoS information set between the fourth relay device 410 and the second relay device 406 to the second relay device 406, for the first end device 402 and the identified peer end devices (here, the second end device 412) in the security procedure after the LER message and/or in the LMR message. The fourth relay device 410 may receive the LEA message and/or the LMA message from the second relay device 406, which may include information of the first end device 402 and the list of the identified peer end devices (here, the second end device 412). The fourth relay device 410 may transmit the LEA message and/or the LMA message to the first end device 402, which may include information of the first end device 402 and the list of identified peer end devices (here, the second end device 412), the QoS information set between the first end device 402 and the fourth relay device 410, associated with the identified peer end devices (here, the second end device 412). The fourth relay device 410 may receive the LMN message from the first end device 402. The fourth relay device 410 may transmit the LMN message to the list of identified peer end devices (here, the second end device 412, via the second relay device 406).

The second end device 412 may function as the peer end device. The second end device 412 may receive the LMN message originated from the second relay device 406, via the third relay device 408. The second end device 412 may exchange traffic with the first end device 402 via the newly selected route between the first end device 402 and the second end device 412.

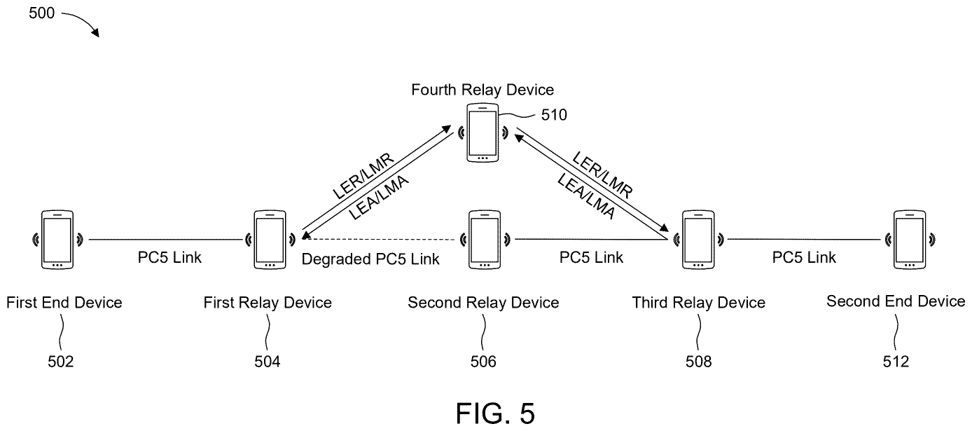

Referring now to FIG. 5, a communication system 500 illustrating an example configuration for a soft reselection between an initiating U2U relay and a responding U2U relay with the responding U2U relay as a candidate U2U relay discoveree is shown according to one or more embodiments. The communication system 500 may include a first end device 502, a first relay device 504, a second relay device 506, a third relay device 508, and a fourth relay device 510, and a second end device 512. Examples of the first end device 502, the first relay device 504, the second relay device 506, the third relay device 408, and the fourth relay device 510, and the second end device 512 include but are not limited to one or more WTRUs, 5G ProSe enabled WTRUs, and/or D2D enabled WTRUs etc. Further, the first end device 502, the first relay device 504, the second relay device 506, the third relay device 508, and the fourth relay device 510, and the second end device 512 may include but are not limited to one or more devices in vehicles and/or carried by pedestrians, one or more network devices and/or infrastructure devices etc.

The first relay device 504 may function as an intermediate end device acting as a U2U relay. The first relay device 504 may detect a link quality degradation between the first relay device 504 and the second relay device 506. The first relay device 504 may transmit a LMR message with a relay reselection indication to the second relay device 506. The second relay device 506 may transmit the LMR message with the relay reselection indication to one or more next hops of the second relay device 506 associated with one or more downstream end devices routed through the degraded link (here, the third relay device 508). The third relay device 508 may transmit a LMA message with the relay reselection indication to the first relay device 504, via the second relay device 506. The first relay device 504 may perform a candidate U2U relay discovery to find and/or determine an alternative route to the third relay device 508 (here, via the fourth relay device 510). The first relay device 504 may set up and/or modify one or more PC5 connections along the newly selected route to the third relay device 508. The first relay device 504 may transmit a LMN message to notify one or more upstream end devices (here, the first end device 502) and the downstream end devices originally routed through the degraded link (here, the second end device 512).

The first end device 502 may function as the upstream end device. The first end device 502 may receive the LMN message from the first relay device 504. The first end device 502 may exchange traffic with the second end device 512 via the newly selected route between the first end device 502 and the second end device 512.

The first relay device 504 may function as detecting, initiating, and/or discoverer end device serving as U2U relay. The first relay device 504 may detect the link quality degradation between the first relay device 504 and the second relay device 506. The first relay device 504 may transmit the LMR message with the relay reselection indication to the second relay device 506, which may include information of a list of downstream end devices originally routed through the degraded link (here, the second end device 512). The first relay device 504 may receive the LMA message with the relay reselection indication from the second relay device 506. The first relay device 504 may determine a list of QoS information sets between the first relay device 504 and the second relay device 506 for the identified downstream end devices (here, the second end device 512) and their identified upstream peer end devices (here, the first end device 502). The first relay device 504 may perform candidate U2U relay discovery to find and/or determine a route to the third relay device 508 (here, via the fourth relay device 510). The first relay device 504 may transmit the LER message and/or the LMR message to the fourth relay device 510, which may include information of the list of identified upstream end devices (here, the first end device 502) and the list of identified downstream end devices (here, the second end device 512). The first relay device 504 may respond to the security establishment with the fourth relay device 510 after the LER message. The first relay device 504 may provide the list of QoS information sets between the first relay device 504 and the second relay device 506 to the fourth relay device 510, for the identified downstream end devices (here, the second end device 512) and their identified upstream peer end devices (here, the first end device 502) in the security procedure after the LER message and/or in the LMR message. The first relay device 504 may receive the LEA message and/or the LMA message from the fourth relay device 510, which may include information of the list of identified upstream end devices (here, the first end device 502) and the list of identified downstream end devices (here, the second end device 512). The first relay device 504 may transmit the LMN message to the list of identified upstream end devices (here, the first end device 502). The first relay device 504 may transmit the LMN message, via the fourth relay device 510, to the list of identified downstream end devices (here, the second end device 512).

The second relay device 506 may be the degraded link peer U2U relay. The second relay device 506 may receive the LMR message with the relay reselection indication from the first relay device 504, which may include information of the list of downstream end devices originally routed through the degraded link (here, the second end device 512). The second relay device 506 may transmit the LMR message with the relay reselection indication to the third relay device 508, which may include information of a sub-list of one or more downstream end devices received from the first relay device 504 (here, the second end device 512) whose next hop is the third relay device 508 and the list of upstream end devices originally routed through the degraded link (here, the first end device 502). The second relay device 506 may receive the LMA message with the relay reselection indication from the third relay device 508, which may include information of the list of identified upstream end devices (here, the first end device 502) and the list of identified downstream end devices (here, the second end device 512). The second relay device 506 may transmit the LMA message with the relay reselection indication to the first relay device 504, which may include information of the sub-list of the upstream end devices received from the third relay device 508 whose next hop is the first relay device 504 (here, the first end device 502) and the list of identified downstream end devices received from the third relay device 508 (here, the second end device 512), the list of the QoS information sets of the second relay device 506 for the list of the identified downstream end devices and their identified upstream peer end devices (here, the first end device 502).

The third relay device 508 may function as the responding and discoveree U2U relay. The third relay device 508 may receive the LMR message with the relay reselection indication from the second relay device 506, which may include information of the list of identified downstream end devices (here, the second end device 512) and the list of identified upstream end devices (here, the second end device 512). The third relay device 508 may transmit the LMA message with the relay reselection indication to the second relay device 506, which may include information of a sub-list of received upstream end devices that are routable by the third relay device 508 (here, the first end device 502) and the list of identified downstream end devices received from the second relay device 506 (here, the second end device 512), the list of the QoS information sets of the second relay device 506 for the list of the identified downstream end devices and the identified upstream peer end devices (here, the first end device 502). The third relay device 508 may receive the LER message and/or the LMR message from the fourth relay device 510, which may include information of the list of identified upstream end devices (here, the first end device 502) and the list of identified downstream end devices (here, the second end device 512). The third relay device 508 may establish security with the fourth relay device 510 if the PC5 connection between the second relay device 506 and the fourth relay device 510 has not been established. The third relay device 508 may transmit the LEA message and/or the LMA message to the fourth relay device 510, which may include information of the list of identified upstream end devices (here, the first end device 502) and the list of identified downstream end devices (here, the second end device 512), the list of QoS information sets between the fourth relay device 510 and the second relay device 506 for the list of identified downstream end devices (here, the second end device 512) and the identified upstream peer end devices (here, the first end device 502). The third relay device 508 may receive the LMN message originated from the first relay device 504, via the fourth relay device 510. The third relay device 508 may transmit the LMN message to the list of identified downstream end devices (here, the second end device 512).

The fourth relay device 510 may function as the alternative U2U relay. The fourth relay device 510 may receive the LER message and/or the LMR message from the first relay device 504, which may include information of the list of identified upstream end devices (here, the first end device 502) and the list of identified downstream end devices (here, the second end device 512). The fourth relay device 510 may establish the security with the first relay device 504 if the PC5 connection between the fourth relay device 510 and the first relay device 504 has not been established. The fourth relay device 510 may determine the list of QoS information sets between the first relay device 504 and the fourth relay device 510 and the list of QoS information sets between the fourth relay device 510 and the second relay device 506 based on the list of QoS information sets between the first relay device 504 and the second relay device 506, for the identified downstream end devices (here, the second end device 512) and their identified upstream peer end devices (here, the first end device 502). The fourth relay device 510 may transmit the LER message and/or the LMR message to the second relay device 506, which may include information of the list of identified upstream end devices (here, the first end device 502) and the list of identified downstream end devices (here, the second end device 512). The fourth relay device 510 may respond to the security establishment with the second relay device 506 after the LER message. The fourth relay device 510 may provide the list of QoS information sets between the fourth relay device 510 and the second relay device 506, for the identified downstream end devices (here, the second end device 512) and their identified upstream peer end devices (here, the first end device 502) in the security procedure after the LER message and/or in the LMR message. The fourth relay device 510 may receive the LEA message and/or the LMA message from the second relay device 506, which may include information of the list of identified upstream end devices (here, the first end device 502) and the list of identified downstream end devices (here, the second end device 512). The fourth relay device 510 may transmit the LEA message and/or the LMA message to the first relay device 504, which may include information of the list of identified upstream end devices (here, the first end device 502) and the list of identified downstream end devices (here, the second end device 512), the list of QoS information sets between the first relay device 504 and the fourth relay device 510 for the list of identified downstream end devices (here, the second end device 512) and the identified upstream peer end devices (here, the first end device 502). The fourth relay device 510 may receive the LMN message from the first relay device 504. The fourth relay device 510 may transmit the LMN message to the list of identified downstream end devices (here, the second end device 512, via the third relay device 508).

The second end device 512 may be the downstream end device. The second end device 512 may receive the LMN message originated from the first relay device 504. The second end device 512 may exchange traffic with the first end device 502 via the newly selected route between the first end device 502 and the second end device 512.

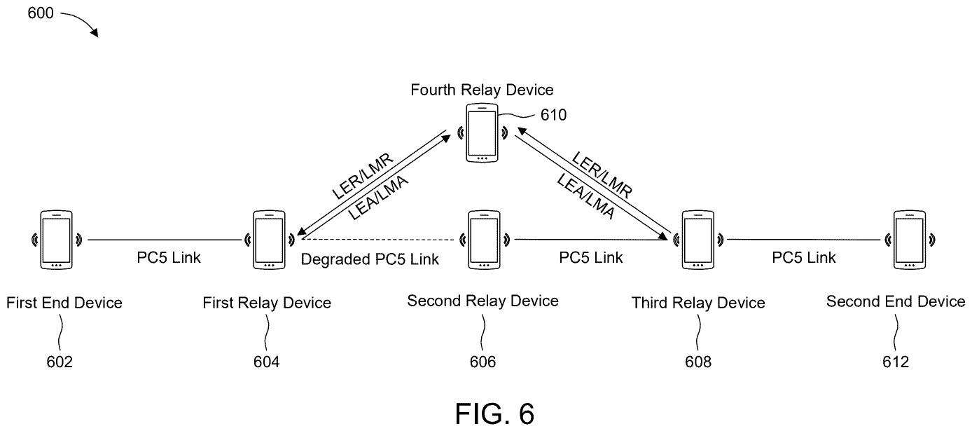

Referring now to FIG. 6, a communication system 600 illustrating an example configuration for a soft reselection between an initiating U2U relay and a responding U2U relay with the initiating U2U relay as a discoveree is shown according to one or more embodiments. The communication system 600 may include a first end device 602, a first relay device 604, a second relay device 606, a third relay device 608, and a fourth relay device 610, and a second end device 612. Examples of the first end device 602, the first relay device 604, the second relay device 606, the third relay device 608, and the fourth relay devices 610, and the second end device 612 include but are not limited to one or more WTRUs, 5G ProSe enabled WTRUs, and/or D2D enabled WTRUs etc. Further, the first end device 602, the first relay device 604, the second relay device 606, the third relay device 608, and the fourth relay device 610, and the second end device 612 may include but are not limited to one or more devices in vehicles and/or carried by pedestrians, one or more network devices and/or infrastructure devices etc.

The first relay device 604 may detect a link quality degradation between the first relay device 604 and the second relay device 606. The first relay device 604 may transmit a LMR message with a relay reselection indication, via the second relay device 606, to the first intermediate end device acting as a U2U relay after passing the degraded link (here, the third relay device 608). If a receiving U2U relay is not an intermediate end device acting as the U2U relay, the receiving U2U relay may proceed to transmit and/or forward the LMR message with the relay reselection indication further downstream until an intermediate end device acting as the U2U relay and/or a downstream end delay is reached. The third relay device 608 may perform a candidate U2U relay discovery to find and/or determine an alternative route to the first relay device 604 (here, via the fourth relay device 610). The third relay device 608 may set up and/or modify one or more PC5 connections along the newly selected route to the first relay device 604. The third relay device 608 may transmit a LMA message with the relay reselection indication to the first relay device 604, via the second relay device 606. The first relay device 604 may transmit a LMN message to notify upstream end device (here, the first end device 602) and downstream end device originally routed through the degraded link (here, the second end device 612).

The first end device 602 may function as an upstream end device. The first end device 602 may receive LMN message from the first relay device 604. The first end device 602 may exchange traffic with the second end device 612 via the newly selected route between the first end device 602 and the second end device 612.

The first relay device 604 may function as detecting, initiating, and discoveree U2U relay. The first relay device 604 may detect the link quality degradation between the first relay device 604 and the second relay device 606. The first relay device 604 may transmit the LMR message with the relay reselection indication to the second relay device 606, which may include information of the list of downstream end devices originally routed through the degraded link (here, the second end device 612), the list of the QoS information sets of the first relay device 604 for the list of identified downstream end devices (here, the second end device 612) and the identified upstream peer end devices (here, the first end device 602). The first relay device 604 may receive the LER message and/or the LMR message from the fourth relay device 610, which may include information of the list of identified downstream end devices and the list of identified upstream end devices. The first relay device 604 may establish security with the fourth relay device 610 if the PC5 connection between the first relay device 604 and the fourth relay device 610 has not been established. The first relay device 604 may transmit the LEA message and/or the LMA message to the fourth relay device 610, which may include information of the list of identified downstream end devices and a list of identified upstream end devices, the list of QoS information sets between the fourth relay device 610 and the first relay device 604 for the list of identified downstream end devices (here, the second end device 612) and the identified upstream peer end devices (here, the first end device 602). The first relay device 604 may receive the LMA message with the relay reselection indication originated from the third relay device 608, via the second relay device 606, which may include information of the list of identified downstream end devices and the list of identified upstream end devices. The first relay device 604 may transmit the LMN message to the list of identified upstream end devices (here, the first end device 602). The first relay device 604 may transmit the LMN message to a list of identified downstream end devices (here, the second end device 612, via the fourth relay device 610).

The second relay device 606 may be the degraded link peer U2U relay. The second relay device 606 may receive the LMR message with the relay reselection indication from the first relay device 604, which may include information of the list of downstream end devices originally routed through the degraded link (here, the second end device 612). The second relay device 606 may transmit the LMR message with the relay reselection indication targeting each next hop (here, the third relay device 608), which may include information of a sub-list of downstream end devices received from the first relay device 604 (here, the second end device 612) whose next hop is the third relay device 608 and the list of upstream end devices originally routed through the degraded link (here, the first end device 602), the list of the QoS information sets of the first relay device 604 associated with the list of identified downstream end devices (here, the second end device 612) and their upstream peer end devices (here, the first end device 602). The second relay device 606 may receive the LMA message with the relay reselection indication from the third relay device 608, which may include information of the list of identified downstream end devices and the list of identified upstream end devices. The second relay device 606 may transmit the LMA message with the relay reselection indication to the first relay device 604, which may include information of the list of identified downstream end devices and the list of identified upstream end devices.

The third relay device 608 may function as responding and/or discoverer end device serving as U2U relay. The third relay device 608 may receive the LMR message with the relay reselection indication originated from the first relay device 604, via the second relay device 606, which may include information of the list of identified downstream end devices (here, the second end device 612) and the list of identified upstream end devices (here, the second end device 612). The third relay device 608 may determine the list of QoS information sets between the third relay device 608 and the first relay device 604 for the list of identified downstream end devices (here, the second end device 612) and the identified upstream peer end devices (here, the first end device 602). The third relay device 608 may perform the candidate U2U relay discovery to find and/or determine the route to the first relay device 604 (here, via the fourth relay device 610). The third relay device 608 may transmit the LER message and/or the LMR message to the fourth relay device 610, which may include information of the list of identified downstream end devices received from the second relay device 606 and the sub-list of identified upstream end devices received from the second relay device 606 that are routable by the third relay device 608 (here, the first end device 602). The third relay device 608 may respond to the security establishment with the fourth relay device 610 after the LER message. The third relay device 608 may provide the list of QoS information sets between the third relay device 608 and the first relay device 604 to the fourth relay device 610, for a list of identified downstream end devices (here, the second end device 612) and the identified upstream peer end devices (here, the first end device 602), in the security procedure after the LER message and/or in the LMR message. The third relay device 608 may receive the LEA message and/or the LMA message from the fourth relay device 610, which may include information of the list of identified downstream end devices and the list of identified upstream end devices. The third relay device 608 may transmit the LMA message with the relay reselection indication to the first relay device 604, via the second relay device 606, which may include information of the list of identified downstream end devices and the list of identified upstream end devices. The third relay device 608 may receive a LMN message originated from the first relay device 604, via the fourth relay device 610. The third relay device 608 may transmit the LMN message to a list of identified downstream end devices (here, the second end device 612).

The fourth relay device 610 may function as the alternative U2U relay. The fourth relay device 610 may receive the LER message and/or the LMR message from the third relay device 608, which may include information of the list of identified downstream end devices and the list of identified upstream end devices. The fourth relay device 610 may establish the security with the third relay device 608 if the PC5 connection between the fourth relay device 610 and the third relay device 608 has not been established. The fourth relay device 610 may determine the list of QoS information sets between the third relay device 608 and the fourth relay device 610 and the list of QoS information sets between the fourth relay device 610 and the first relay device 604 based on the list of QoS information sets between the third relay device 608 and the first relay device 604 received from the third relay device 608, for the list of identified downstream end devices (here, the second end device 612) and the identified upstream peer end devices (here, the first end device 602). The fourth relay device 610 may transmit the LER message and/or the LMR message to the first relay device 604, which may include information of the list of identified downstream end devices and the list of identified upstream end devices. The fourth relay device 610 may respond to the security establishment with the first relay device 604 after the LER message. The fourth relay device 610 may provide the list of QoS information sets between the fourth relay device 610 and the first relay device 604 to the first relay device 604, for the identified downstream end devices (here, the second end device 612) and the identified upstream peer end devices (here, the first end device 602) in the security procedure after the LER message and/or in the LMR. The fourth relay device 610 may receive the LEA message and/or the LMA message from the first relay device 604, which may include information of the list of identified downstream end devices and the list of identified upstream end devices. The fourth relay device 610 may transmit the LEA message and/or the LMA message to the third relay device 608, which may include information of the list of identified downstream end devices and the list of identified upstream end devices, the list of QoS information sets between the third relay device 608 and the fourth relay device 610 for the list of identified downstream end devices (here, the second end device 612) and the identified upstream peer end devices (here, the first end device 602). The fourth relay device 610 may receive the LMN message from the first relay device 604. The fourth relay device 610 may transmit the LMN message to the list of identified downstream end devices (here, the second end device 612, via the third relay device 608).

The second end device 612 may function as the downstream end device. The second end device 612 may receive the LMN message originated from the first relay device 604, via the third relay device 608. The second end device 612 may exchange traffic with the first end device 602 via the newly selected route between the first end device 602 and the second end device 612.

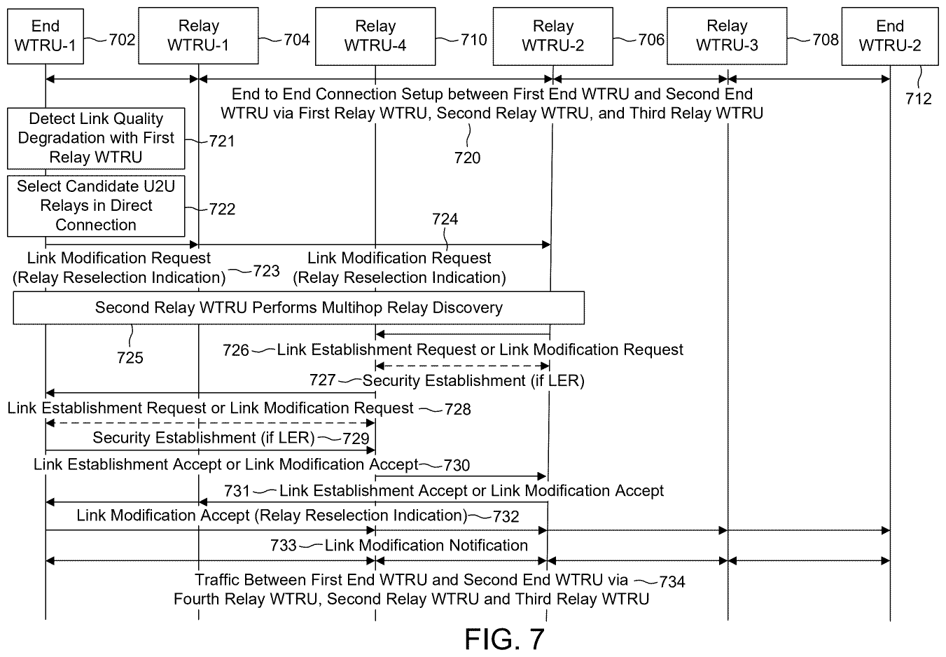

Referring now to FIG. 7, a flow diagram illustrating an example process for a negotiated reselection between an initiating end WTRU and a responding U2U relay is shown according to one or more embodiments. The process may be used in a communication system including a first end WTRU 702, a first relay WTRU 704, a second relay WTRU 706, a third relay WTRU 708, a fourth relay WTRU 710, and a second end WTRU 712.

In a WTRU-to-WTRU relay mesh network, a link quality degradation may occur between an end WTRU and a neighbor U2U relay due to WTRU mobility and/or radio frequency (RF) environmental changes. When this happens, it would be beneficial to have an option for the link degradation detecting end WTRU to perform WTRU-to-WTRU relay reselection with a responding U2U relay to circumvent the degraded link without changing the remaining parts of the end-to-end routes with its peer end WTRUs originally routed through the degraded link, before resorting to the end-to-end WTRU-to-WTRU relay reselection.

In an embodiment, the present disclosure provides a local WTRU-to-WTRU relay reselection procedure to facilitate the (initiating) link degradation detecting end WTRU (here, the first end WTRU 702) to perform negotiated local WTRU-to-WTRU relay reselection with a responding intermediate end WTRU acting as a U2U relay (here, the second relay WTRU 706), that knows an active route to any of its peer end WTRUs originally routed through the degraded link (here, the second end WTRU 712) to discover an alternative route to the responding U2U relay (here, the second relay WTRU 706).

At 720, the first end WTRU 702 and the second end WTRU 712 may set up hop-by-hop PC5 connections via the first relay WTRU 704, the second relay WTRU 706 and the third relay WTRU 708 for end-to-end communication between the first end WTRU 702 and the second end WTRU 712. The first end WTRU 702 and the second end WTRU 712 may exchange data traffic via the first relay WTRU 704, the second relay WTRU 706 and the third relay WTRU 708. The first end WTRU 702, the second end WTRU 712, the first relay WTRU 704, the second relay WTRU 706, the third relay WTRU 708, and the fourth relay WTRU 710 are provisioned with the discovery security materials associated with the authorized RSC. The first end WTRU 702, the second end WTRU 712, and the second relay WTRU 706 (an intermediate end WTRU acting as a U2U relay) are provisioned with the direct discovery security materials (i.e., discovery security materials associated with a prose direct discovery service for restricted prose direct discovery).

At 721, the first end WTRU 702 may detect the link quality degradation between the first end WTRU 702 and the first relay WTRU 704.

At 722, the first end WTRU 702 may obtain and/or select a list of candidate U2U relays which are accessible by the first end WTRU 702 in a direct PC5 connection.

At 723, the first end WTRU 702 may transmit a LMR message with a relay reselection indication to the first relay WTRU 704, which may include information of a list of one or more candidate U2U relays (here, the fourth relay WTRU 710), information of the first end WTRU 702 and a list of identified peer end WTRUs of the first end WTRU 702 that are routable via the first relay WTRU 704 (here, the second end WTRU 712), end-to-end QoS information set for the first end WTRU 702 and the identified peer end WTRUs of the first end WTRU 702 (here, the second end WTRU 712), which includes, for end-to-end connections with the first end WTRU 702 being the source end WTRU during link establishment, the end-to-end QoS information between the first end WTRU 702 and each of the identified peer target end WTRUs of the first end WTRU 702 (here, the second end WTRU 712). For end-to-end connections with the first end WTRU 702 being the target end WTRU during link establishment, the end-to-end QoS information=NA between the first end WTRU 702 and each of the identified peer source end WTRUs of the first end WTRU 702 (here, the first end WTRU 702).

At 724, the first relay WTRU 704 may transmit the LMR message with the relay reselection indication to the second relay WTRU 706, which may include information of a list of one or more candidate U2U relays (here, the fourth relay WTRU 710), information of the first end WTRU 702 and a list of identified peer end WTRUs of the first end WTRU 702 (here, the second end WTRU 712) that are routable by the first relay WTRU 704 via the corresponding next-hop U2U relay (here, the second relay WTRU 706), end-to-end QoS information set for the first end WTRU 702 and the identified peer end WTRUs of the first end WTRU 702 (here, the second end WTRU 712).

The second relay WTRU 706 may determine the QoS information set between the second relay WTRU 706 and the first end WTRU 702 associated with the identified peer end WTRUs of the first end WTRU 702 received from the first relay WTRU 704. In that, for end-to-end connections with the first end WTRU 702 being the source end WTRU in the QoS context of the unicast routing table of the second relay WTRU 706, the second relay WTRU 706 may determine the QoS information between the second relay WTRU 706 and the first end WTRU 702 based on the received end-to-end QoS information for the first end WTRU 702 and each of the identified peer end WTRUs of the first end WTRU 702 (here, the second end WTRU 712) as received in the end-to-end QoS information set for the first end WTRU 702 and the identified peer end WTRUs of the first end WTRU 702 from the first relay WTRU 704, and the QoS information between the second relay WTRU 706 and each of the identified peer end WTRUs of the first end WTRU 702 as target end WTRU in the QoS context. For end-to-end connections with the first end WTRU 702 being the target end WTRU in the QoS context of the unicast routing table of the second relay WTRU 706, the second relay WTRU 706 may determine the QoS information between the second relay WTRU 706 and the first end WTRU 702 associated with each of the identified peer end WTRUs of the first end WTRU 702 (here, the second end WTRU 712) received from the first relay WTRU 704 as source end WTRU in the QoS context, based on the information in the QoS context.

At 725, the second relay WTRU 706 (the first intermediate end WTRU acting as a U2U relay along the path to any of the identified peer end WTRUs of the first end WTRU 702) may perform candidate U2U relay discovery to select a U2U relay (here, the fourth relay WTRU 710) among the received candidate U2U relays, along with the corresponding route.

At 726, the second relay WTRU 706 may transmit the LER message and/or the LMR message to the fourth relay WTRU 710, which may include information of responding U2U relay (here, the second relay WTRU 706), information of the first end WTRU 702 and a list of the identified peer end WTRUs of the first end WTRU 702 received from the first relay WTRU 704 that are routable by the second relay WTRU 706 (here, the second end WTRU 712). The fourth relay WTRU 710 may add a route entry with a destination to each of the identified peer end WTRUs of the first end WTRU 702 in its unicast routing table, with the second relay WTRU 706 as the next hop.

At 727, the fourth relay WTRU 710 may establish security with the second relay WTRU 706 if the PC5 connection between the fourth relay WTRU 710 and the second relay WTRU 706 has not been established. In the security procedure after the LER message and/or in the LMR message, the second relay WTRU 706 may provide the QoS information set between the second relay WTRU 706 and the first end WTRU 702 to the fourth relay WTRU 710, associated with the identified peer end WTRUs of the first end WTRU 702 (here, the second end WTRU 712) received from the first relay WTRU 704. The fourth relay WTRU 710 may determine the QoS information set between the second relay WTRU 706 and the fourth relay WTRU 710 and the QoS information set between the fourth relay WTRU 710 and the first end WTRU 702 based on the QoS information set between the second relay WTRU 706 and the first end WTRU 702 received from the second relay WTRU 706, for the first end WTRU 702 and the identified peer end WTRUs of the first end WTRU 702 (here, the second end WTRU 712).

At 728, the fourth relay WTRU 710 may transmit the LER message and/or the LMR message to the first end WTRU 702, which may include information of responding U2U relay (here, the second relay WTRU 706), information of the first end WTRU 702 and a list of the identified peer end WTRUs of the first end WTRU 702 in the received LER message and/or the LMR message from the second relay WTRU 706. The first end WTRU 702 may add a route entry to each of the identified peer end WTRUs (here, the second end WTRU 712) in the received LER message and/or LMR message in the unicast routing table, with the fourth relay WTRU 710 as the next hop.

At 729, the first end WTRU 702 may establish the security with the fourth relay WTRU 710 if the PC5 connection between the first end WTRU 702 and the fourth relay WTRU 710 has not been established. In the security procedure after the LER message and/or in the LMR message, the fourth relay WTRU 710 may provide the QoS information set between the fourth relay WTRU 710 and the first end WTRU 702 to the first end WTRU 702, associated with the identified peer end WTRUs of the first end WTRU 702 (here, the second end WTRU 712) received from the second relay WTRU 706.

At 730, the first end WTRU 702 may transmit the LEA message and/or the LMA message to the fourth relay WTRU 710, which may include information of responding U2U relay (here, the second relay WTRU 706), information of the first end WTRU 702 and the list of identified peer end WTRUs of the first end WTRU 702 (here, the second end WTRU 712) received in the LER message and/or the LMR message from the fourth relay WTRU 710 (here, the second end WTRU 712), the QoS information set between the fourth relay WTRU 710 and the first end WTRU 702, associated with the identified peer end WTRUs of the first end WTRU 702.

The fourth relay WTRU 710 may add a route entry to the first end WTRU 702 in its unicast routing table. After the PC5 connection setup with the fourth relay WTRU 710, the first end WTRU 702 may receive the IP address from the fourth relay WTRU 710 or assign a link local IP address.

At 731, the fourth relay WTRU 710 may transmit the LEA message and/or the LMA message to the second relay WTRU 706, which may include information of responding U2U relay (here, the second relay WTRU 706), information of the first end WTRU 702 and the list of identified peer end WTRUs of the first end WTRU 702 (here, the second end WTRU 712), the QoS information set between the second relay WTRU 706 and the fourth relay WTRU 710, considering the received QoS information set between the fourth relay WTRU 710 and the first end WTRU 702, for the first end WTRU 702 and the identified peer end WTRUs of the first end WTRU 702 (here, the second end WTRU 712). The second relay WTRU 706 may add a route entry to the first end WTRU 702 in its unicast routing table, with the fourth relay WTRU 710 as the next hop.

At 732, the second relay WTRU 706 may transmit the LMA message with the relay reselection indication to the first end WTRU 702, via the first relay WTRU 704, which may include information of responding U2U relay (here the second relay WTRU 706), information of the first end WTRU 702 and a list of identified peer end WTRUs of the first end WTRU 702 (here, the second end WTRU 712). Upon receiving the LMA message with the relay reselection indication, the first end WTRU 702 may remove the original route entry (via the first relay WTRU 704) to each of its identified peer end WTRUs in its unicast routing table.

At 733, the first end WTRU 702 may transmit a LMN message to a list of identified peer end WTRUs of the first end WTRU 702 (here, the second end WTRU 712), via the fourth relay WTRU 710, which may include information of the first end WTRU 702 and a list of identified peer end WTRUs of the first end WTRU 702 (here, the second end WTRU 712), to facilitate updating of a route entry (e.g., hop count) to the first end WTRU 702 along the paths to the identified peer end WTRUs of the first end WTRU 702.

The LMN message may include the IP address of the first end WTRU 702. The LMN message may be forwarded to each identified peer end WTRU based on the unicast routing table hop by hop. At each intermediate U2U relay, the received list of identified peer end WTRUs may be split into multiple sub-lists with each sub-list including identified peer end WTRUs associated with the same next hop and transmitted in a separate LMN message via the corresponding next hop. Upon receiving the LMN message, the second relay WTRU 706 may remove the original route entry (via the first relay WTRU 704) to the first end WTRU 702 in its unicast routing table.

At 734, after successful connection setup between the first end WTRU 702 and the second relay WTRU 706 (here, via the fourth relay WTRU 710) and notifications to the identified peer end WTRUs of the first end WTRU 702, as well as any further Layer 3 and/or Layer 2 end-to-end QoS reconfiguration (as needed), the first end WTRU 702 and the second end WTRU 712 may transfer traffic via the newly selected route between the first end WTRU 702 and the second end WTRU 712 (here, [the first end WTRU 702, the fourth relay WTRU 710, the second relay WTRU 706, the third relay WTRU 708, the second end WTRU 712]).

If the second relay WTRU 706 cannot find and/or determine any route to the candidate U2U relays transmitted by the first end WTRU 702 in the LMR message with the relay reselection indication via candidate U2U relay discovery for a preconfigured period of time, the second relay WTRU 706 may transmit the LMR message with the relay reselection indication to each of the next hops, which may be one of the peer end WTRUs of the first end WTRU 702 or a U2U relay associated with one of more peer end WTRUs of the first end WTRU 702, including information of the list of the one or more candidate U2U relays transmitted by the first end WTRU 702, information of one of the peer end WTRUs of the first end WTRU 702 directly connected to the second relay WTRU 706 or the list of the peer end WTRUs of the first end WTRU 702 (here, the second end WTRU 712) that are routable by the second relay WTRU 706 via the corresponding next-hop U2U relay.

If the next hop is a directly connected peer end WTRUs of the first end WTRU 702, the receiving end WTRU may perform negotiated end-to-end WTRU-to-WTRU relay reselection with the first end WTRU 702. If the next hop is a U2U relay, the next hop (here, the third relay WTRU 708) may transmit the LMR message with the relay reselection indication further downstream to each of its next hops, with each next hop being a directly connected the peer end WTRU of the first end WTRU 702 (here, the second end WTRU 712) or U2U relay associated with one of more of the peer end WTRUs of the first end WTRU 702 that are routable by the third relay WTRU 708 via the corresponding next-hop U2U relay.

If the next hop is an intermediate end WTRU acting as a U2U relay, the next hop may perform negotiated local WTRU-to-WTRU relay reselection with the first end WTRU 702 first and may transmit the LMR message with the relay reselection indication further downstream if negotiated local WTRU-to-WTRU relay reselection with the first end WTRU 702 is unsuccessful.

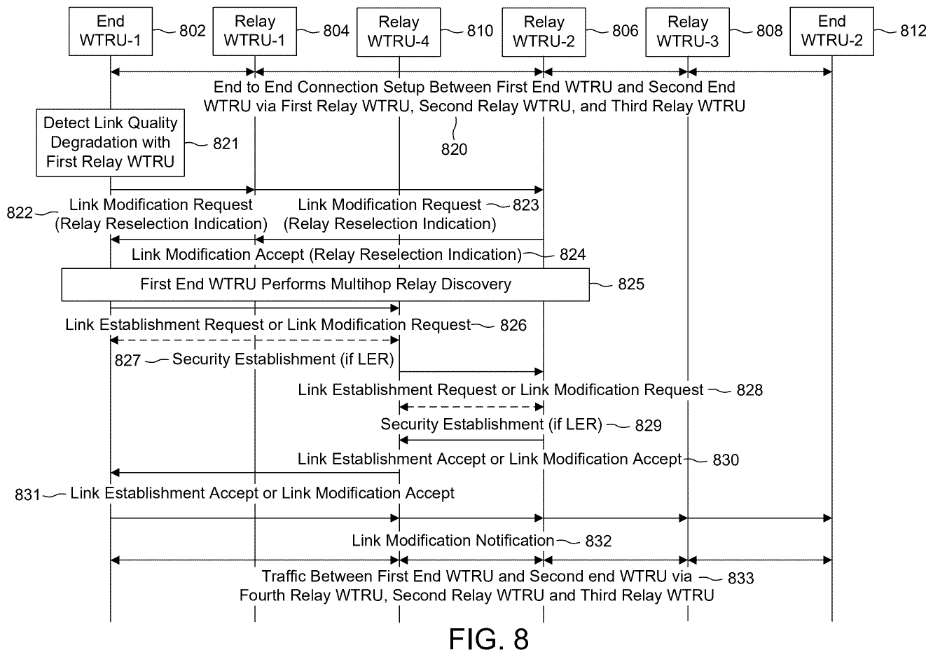

Referring now to FIG. 8, a flow diagram illustrating an example process for a soft reselection between an initiating end WTRU and a responding U2U relay with the responding U2U relay as a candidate U2U relay discoveree is shown according to one or more embodiments. The process may be used in a communication system including a first end WTRU 802, a first relay WTRU 804, a second relay WTRU 806, a third relay WTRU 808, a fourth relay WTRU 810, and a second end WTRU 812.

In a WTRU-to-WTRU relay mesh network, a link quality degradation may occur between an end WTRU and a neighbor U2U relay due to WTRU mobility and/or RF environmental changes. When this happens, it would be beneficial to have the option for the link degradation detecting end WTRU to perform WTRU-to-WTRU relay reselection with a responding U2U relay to circumvent the degraded link without changing the remaining parts of the end-to-end routes with its peer end WTRUs originally routed through the degraded link, before resorting to the end-to-end WTRU-to-WTRU relay reselection.

In an embodiment, the present disclosure provides a local WTRU-to-WTRU relay soft reselection procedure to facilitate the (initiating) link degradation detecting end WTRU (here, the first end WTRU 802) to perform candidate WTRU-to-WTRU relay discovery to discover an alternative route to each responding next hop (here, the second relay WTRU 806) of the degraded link peer U2U relay (here, the first relay WTRU 804) that knows an active route to any of its peer end WTRUs originally routed through the degraded link (here, the second end WTRU 812).

At 820, the first end WTRU 802 and the second end WTRU 812 may set up hop-by-hop PC5 connections via the first relay WTRU 804, the second relay WTRU 806 and the third relay WTRU 808 for end-to-end communication between the first end WTRU 802 and the second end WTRU 812, and the first end WTRU 802 and the second end WTRU 812 may exchange data traffic via the first relay WTRU 804, the second relay WTRU 806 and the third relay WTRU 808.

The first end WTRU 802, the second end WTRU 812, the first relay WTRU 804, the second relay WTRU 806, the third relay WTRU 808, and the fourth relay WTRU 810 are provisioned with the discovery security materials associated with the authorized RSC.

The first end WTRU 802 and the second end WTRU 812 are provisioned with the direct discovery security materials (i.e., discovery security materials associated with a prose direct discovery service for restricted prose direct discovery).

At 821, the first end WTRU 802 may detect the link quality degradation between the first end WTRU 802 and the first relay WTRU 804.

At 822, the first end WTRU 802 transmits the LMR message with the relay reselection indication to the first relay WTRU 804, which may include information of the first end WTRU 802 and a list of identified peer end WTRUs that are routable via the first relay WTRU 804 (here, the second end WTRU 812), end-to-end QoS information set for the first end WTRU 802 and the identified peer end WTRUs of the first end WTRU 802 (here, the second end WTRU 812).

The end-to-end QoS information set may include, for end-to-end connections with the first end WTRU 802 being the source end WTRU during link establishment, the end-to-end QoS information between the first end WTRU 802 and each of the identified peer target end WTRUs of the first end WTRU 802 (here, the second end WTRU 812).

The end-to-end QoS information set may include, for end-to-end connections with the first end WTRU 802 being the target end WTRU during link establishment, the end-to-end QoS information=NA between the first end WTRU 802 and each of the identified peer source end WTRUs of the first end WTRU 802 (here, the first end WTRU 802).

At 823, the first relay WTRU 804 may transmit a LMR message with a relay reselection indication to each of one or more next-hop U2U relays for the identified peer end WTRUs of the first end WTRU 802 (here, the second relay WTRU 806), which may include information of the first end WTRU 802 and the sub-list of the identified peer end WTRUs of the first end WTRU 802 (here, the second end WTRU 812) routable through the corresponding next hop U2U relay, end-to-end QoS information set for the first end WTRU 802 and the identified peer end WTRUs of the first end WTRU 802 (here, the second end WTRU 812), including end-to-end QoS information for the peer end WTRUs of the first end WTRU 802 that are in the included the sub-list of the identified peer end WTRUs of the first end WTRU 802 (here, the first end WTRU 802).

At 824, the second relay WTRU 806 may transmit a LMA message with relay reselection indication to the first end WTRU 802, via the first relay WTRU 804, which may include information of responding U2U relay (here, the second relay WTRU 806), information of the first end WTRU 802 and a list of identified peer end WTRUs of the first end WTRU 802 received from the first relay WTRU 804 (here, the second end WTRU 812), the QoS information set between the first end WTRU 802 and the second relay WTRU 806 associated with the identified peer end WTRUs of the first end WTRU 802 (here, the second end WTRU 812).

The second relay WTRU 806 may determine the QoS information set between the first end WTRU 802 and the second relay WTRU 806 associated with the identified peer end WTRUs of the first end WTRU 802.

The QoS information set may include, for end-to-end connections with the first end WTRU 802 being the source end WTRU in the QoS context of a unicast routing table of the second relay WTRU 806, the second relay WTRU 806 may determine the QoS information between the first end WTRU 802 and the second relay WTRU 806 based on the end-to-end QoS information for the first end WTRU 802 and each of the identified peer end WTRUs of the first end WTRU 802 (here, the second end WTRU 812) as received in the end-to-end QoS information set for the first end WTRU 802 and the identified peer end WTRUs of the first end WTRU 802 from the first relay WTRU 804, and the QoS information between the second relay WTRU 806 and each of the identified peer end WTRUs of the first end WTRU 802 as target end WTRU in the QoS context.

The QoS information set may include, for end-to-end connections with the first end WTRU 802 being the target end WTRU in the QoS context of the unicast routing table of the second relay WTRU 806, the second relay WTRU 806 may determine the QoS information between the first end WTRU 802 and the second relay WTRU 806 associated with each of the identified peer end WTRUs of the first end WTRU 802 (here, the second end WTRU 812) received from the first relay WTRU 804 as the source end WTRU in the QoS context, based on the information in the WTRU context.

At 825, the first end WTRU 802 may perform candidate U2U relay discovery to find and/or determine an alternative route to the responding U2U relay (here, [the first end WTRU 802 the fourth relay WTRU 810, the second relay WTRU 806]).

At 826, the first end WTRU 802 may transmit a LER message and/or a LMR message to the fourth relay WTRU 810, which may include information of responding U2U relay (here, the second relay WTRU 806), information of the first end WTRU 802 and the list of identified peer end WTRUs of the first end WTRU 802 received in the LMA message with the relay reselection indication from the first relay WTRU 804 (here, the second end WTRU 812). If the fourth relay WTRU 810 receives the LER message from the first end WTRU 802, the fourth relay WTRU 810 may add a route entry to the first end WTRU 802 in its unicast routing table after security establishment with the first end WTRU 802. If the fourth relay WTRU 810 may receive the LMR message from the first end WTRU 802, the fourth relay WTRU 810 may add a route entry to the first end WTRU 802 in its unicast routing table.

At 827, the fourth relay WTRU 810 may establish security with the first end WTRU 802 if the PC5 connection between the fourth relay WTRU 810 and the first end WTRU 802 has not been established.

In the security procedure after the LER message and/or in the LMR message, the first end WTRU 802 may provide the QoS information set between the first end WTRU 802 and the second relay WTRU 806 to the fourth relay WTRU 810, associated with the identified peer end WTRUs of the first end WTRU 802 (here, the second end WTRU 812) received in the LMA message with relay reselection indication from the first relay WTRU 804.

The fourth relay WTRU 810 may determine the QoS information set between the first end WTRU 802 and the fourth relay WTRU 810 and the QoS information set between the fourth relay WTRU 810 and the second relay WTRU 806 based on the QoS information set between the first end WTRU 802 and the second relay WTRU 806, for the first end WTRU 802 and the identified peer end WTRUs of the first end WTRU 802 (here, the second end WTRU 812).

At 828, the fourth relay WTRU 810 may transmit the LER message and/or the LMR message to the second relay WTRU 806, which may include information of responding U2U relay (here, the second relay WTRU 806), information of the first end WTRU 802 and a list of identified peer end WTRUs of the first end WTRU 802 received in the LER message and/or the LMR message from the first end WTRU 802 (here, the second end WTRU 812).

If the second relay WTRU 806 receives the LER message from the fourth relay WTRU 810, the second relay WTRU 806 may add a route entry to the first end WTRU 802 in its unicast routing table after security establishment, with the fourth relay WTRU 810 as the next hop.

If the second relay WTRU 806 receives the LMR message from the fourth relay WTRU 810, the second relay WTRU 806 may add a route entry to the first end WTRU 802 in its unicast routing table, with the fourth relay WTRU 810 as the next hop.

At 829, the second relay WTRU 806 may establish security with the fourth relay WTRU 810 if the PC5 connection between the second relay WTRU 806 and the fourth relay WTRU 810 has not been established.

In the security procedure after the LER message and/or in the LMR message, the fourth relay WTRU 810 may provide the QoS information set between the fourth relay WTRU 810 and the second relay WTRU 806 to the second relay WTRU 806, for the first end WTRU 802 and the identified peer end WTRUs of the first end WTRU 802 (here, the second end WTRU 812) received from the first end WTRU 802.

At 830, the second relay WTRU 806 may reply with a LEA message and/or a LMA message to the fourth relay WTRU 810, which may include information of responding U2U relay (here, the second relay WTRU 806), information of the first end WTRU 802 and a list of identified peer end WTRUs of the first end WTRU 802 (here, the second end WTRU 812), the QoS information set between the fourth relay WTRU 810 and the second relay WTRU 806, for the first end WTRU 802 and the identified peer end WTRUs of the first end WTRU 802 (here, the second end WTRU 812). The fourth relay WTRU 810 may add a route entry to each of the identified peer end WTRUs of the first end WTRU 802 in its unicast routing table, with the second relay WTRU 806 as the next hop.

At 831, the fourth relay WTRU 810 may transmit the LEA message and/or the LMA message to the first end WTRU 802, which may include information of responding U2U relay (here, the second relay WTRU 806), information of the first end WTRU 802 and a list of identified peer end WTRUs of the first end WTRU 802 (here, the second end WTRU 812), the QoS information set between the first end WTRU 802 and the fourth relay WTRU 810, considering the received QoS information set between the fourth relay WTRU 810 and the second relay WTRU 806 from the second relay WTRU 806, for the first end WTRU 802 and the identified peer end WTRUs of the first end WTRU 802 (here, the second end WTRU 812). The first end WTRU 802 may add a route entry to each of the identified peer end WTRUs of the first end WTRU 802 received in the LEA message and/or the LMA message in its unicast routing table, with the fourth relay WTRU 810 as the next hop, and may remove the corresponding original route entry (via the first relay WTRU 804) to each identified peer end WTRU. After PC5 connection setup with the fourth relay WTRU 810, the first end WTRU 802 may get the IP address from the fourth relay WTRU 810 or assign a link local IP address.

At 832, the first end WTRU 802 may transmit a LMN message to the list of identified peer end WTRUs of the first end WTRU 802 (here, the second end WTRU 812) received in the LEA message and/or the LMA message from the fourth relay WTRU 810, via the fourth relay WTRU 810, which may include information of the first end WTRU 802 and a list of identified peer end WTRUs of the first end WTRU 802 (here, the second end WTRU 812), to facilitate updating of route entry (e.g., hop count) to the first end WTRU 802 along the paths to the identified peer end WTRUs of the first end WTRU 802.

The LMN message may include the IP address of the first end WTRU 802. The LMN message may be forwarded to each identified peer end WTRU based on the unicast routing table hop by hop. At each intermediate U2U relay, the received list of identified peer end WTRUs may be split into multiple sub-lists with each sub-list including identified peer end WTRUs associated with the same next hop and sent in a separate LMN message via the corresponding next hop. Upon receiving the LMN message from the fourth relay WTRU 810, the second relay WTRU 806 may remove the original route entry (via the first relay WTRU 804) to the first end WTRU 802 in its unicast routing table.

At 833, after successful connection setup between the first end WTRU 802 and the second relay WTRU 806 (here, via the fourth relay WTRU 810) and notifications to the identified peer end WTRUs of the first end WTRU 802, as well as any further Layer 3 and/or Layer 2 end-to-end QoS reconfiguration (as needed), the first end WTRU 802 and the second end WTRU 812 may transfer traffic via the newly selected route between the first end WTRU 802 and the second end WTRU 812 (here, [the first end WTRU 802, the fourth relay WTRU 810, the second relay WTRU 806, the third relay WTRU 808, the second end WTRU 812]).

In an example, the second relay WTRU 806 may also include information of the list of next-hop U2U relays (here, the third relay WTRU 808) and the associated peer end WTRUs of the first end WTRU 802 in the LMA message with the relay reselection indication transmitted to the first end WTRU 802 (via the first relay WTRU 804).

In an example, the first end WTRU 802 may perform candidate U2U relay discovery to find and/or determine a route to the second relay WTRU 806 and/or one or more next-hop U2U relays of the second relay WTRU 806 (with each candidate U2U relay associated with one or more peer end WTRUs of the first end WTRU 802), either sequentially (e.g., discover the second relay WTRU 806 first; if unsuccessful, discover the next-hop U2U relays) or in parallel.

If the first end WTRU 802 still cannot find and/or determine an alternative route to any of its identified peer end WTRUs for a preconfigured period of time, the first end WTRU 802 may initiate negotiated local and/or end-to-end U2U relay reselection similar to FIG. 7.

The first end WTRU 802 may transmit the LMR message with the relay reselection indication to the first relay WTRU 804, which may include information of the list of candidate U2U relays accessible by the first end WTRU 802 in direct PC5 connection, information of the list of peer end WTRUs of the first end WTRU 802 that are routable via the first relay WTRU 804 (here, the second end WTRU 812) but still un-reroutable after the above procedure is performed.

The first relay WTRU 804 may transmit the LMR message with the relay reselection indication to the second relay WTRU 806, which may include information of the list of candidate U2U relays transmitted by the first end WTRU 802, information of the sub-list of peer end WTRUs of the first end WTRU 802 (here, the second end WTRU 812) that are routable by the first relay WTRU 804 via the corresponding next-hop U2U relay (here, the second relay WTRU 806) but still un-reroutable.

The second relay WTRU 806 may transmit the LMR message with the relay reselection indication to each of the next hops, which may be one of the un-reroutable peer end WTRUs of the first end WTRU 802 or a U2U relay associated with one of more of the un-reroutable peer end WTRUs of the first end WTRU 802, including information of the list of candidate U2U relays transmitted by the first end WTRU 802, information of a directly connected un-reroutable peer end WTRU of the first end WTRU 802 and/or one or more next-hop U2U relays (here, the third relay WTRU 808) and their associated lists of the un-reroutable peer end WTRUs of the first end WTRU 802 (here, the second end WTRU 812) that are routable by the second relay WTRU 806 via the corresponding next-hop U2U relay (here, the third relay WTRU 808). If the next hop is one of the un-reroutable peer end WTRUs of the first end WTRU 802, the receiving end WTRU (here, the second end WTRU 812) may perform negotiated end-to-end WTRU-to-WTRU relay reselection with the first end WTRU 802. If the next hop is a U2U relay (here, the third relay WTRU 808), the next hop may transmit the LMR message with the relay reselection indication further downstream to each of its next hops, with each next hop being one of the un-reroutable peer end WTRUs of the first end WTRU 802 (here, the second end WTRU 812) or the U2U relay associated with one of more of the un-reroutable peer end WTRUs of the first end WTRU 802. If the next hop is an intermediate end WTRU acting as a U2U relay, the next hop may perform negotiated local WTRU-to-WTRU relay reselection with the first end WTRU 802 first and may transmit the LMR message with the relay reselection indication further downstream if negotiated local WTRU-to-WTRU relay reselection with the first end WTRU 802 is unsuccessful.

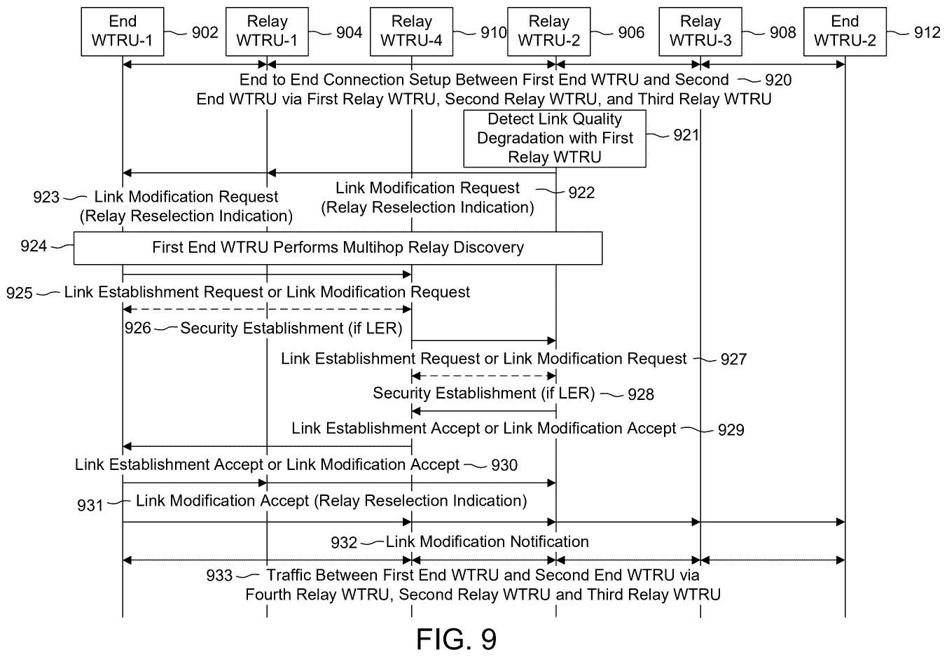

Referring now to FIG. 9, a flow diagram illustrating an example process for a soft reselection between an initiating U2U relay and an end WTRU with the initiating U2U relay as a candidate U2U relay discoveree is shown according to one or more embodiments. The process may be used in a communication system including a first end WTRU 902, a first relay WTRU 904, a second relay WTRU 906, a third relay WTRU 908, a fourth relay WTRU 910, and a second end WTRU 912.

In a WTRU-to-WTRU relay mesh network, the link quality between a pair of intermediate U2U relays may degrade due to WTRU mobility and/or RF environmental changes. When this happens, it would be beneficial to have the option for the link degradation detecting U2U relay to initiate local WTRU-to-WTRU relay reselection with a responding end WTRU to circumvent the degraded link without changing the remaining parts of the end-to-end routes between each pair of (upstream and downstream) end WTRUs originally routed through the degraded link (here, the first end WTRU 902 and the second end WTRU 912), before resorting to the end-to-end WTRU-to-WTRU relay reselection.

In various embodiments, the present disclosure describes a local WTRU-to-WTRU relay soft reselection procedure for the (initiating) link degradation detecting U2U relay (here, the second relay WTRU 906) to indicate to a responding end WTRU (here, the first end WTRU 902) beyond the peer U2U relay of the degraded link (here, the first relay WTRU 904), and originally routed through the degraded link, to perform candidate WTRU-to-WTRU relay discovery to discover an alternative route to the initiating U2U relay (here, the second relay WTRU 906).

At 920, the first end WTRU 902 and the second end WTRU 912 may set up hop-by-hop PC5 connections via the first relay WTRU 904, the second relay WTRU 906 and the third relay WTRU 908 for end-to-end communication between the first end WTRU 902 and the second end WTRU 912. The first end WTRU 902 and the second end WTRU 912 may exchange data traffic via the first relay WTRU 904, the second relay WTRU 906 and the third relay WTRU 908. The first end WTRU 902, the second end WTRU 912, the first relay WTRU 904, the second relay WTRU 906, the third relay WTRU 908, and the fourth relay WTRU 910 are provisioned with the discovery security materials associated with the authorized RSC. The first end WTRU 902 and the second end WTRU 912 are provisioned with the direct discovery security materials (i.e., discovery security materials associated with a prose direct discovery service for restricted prose direct discovery).

At 921, the second relay WTRU 906 may detect a link quality degradation between the first relay WTRU 904 and the second relay WTRU 906.

At 922, the second relay WTRU 906 may transmit a LMR message with a relay reselection indication to the first relay WTRU 904, which may include information of initiating U2U relay (here, the second relay WTRU 906), information of a list of identified upstream end WTRUs whose next hop is the first relay WTRU 904 (here, the first end WTRU 902), a list of QoS information sets of the second relay WTRU 906 for the included list of identified upstream end WTRUs (here, the first end WTRU 902) and their associated downstream peer end WTRUs (here, the second end WTRU 912). The QoS information set of the second relay WTRU 906 for the first end WTRU 902 and the associated peer end WTRUs of the first end WTRU 902 (here, the second end WTRU 912) includes, for end-to-end connections with the first end WTRU 902 being the source end WTRU in the QoS context of the unicast routing table of the second relay WTRU 906, the QoS information between the second relay WTRU 906 and each of the peer target end WTRU of the first end WTRU 902 (here, the second end WTRU 912) in the QoS context, based on the information in the QoS context.

The QoS information set includes, for end-to-end connections with the first end WTRU 902 being the target end WTRU in the QoS context of the unicast routing table of the second relay WTRU 906, the QoS information between the second relay WTRU 906 and the first end WTRU 902 associated with each of the peer source end WTRUs of the first end WTRU 902 (here, the second end WTRU 912) in the QoS context, based on the information in the QoS context.

At 923, the first relay WTRU 904 may transmit the LMR message with the relay reselection indication to each identified upstream end WTRU received from the second relay WTRU 906 (here, the first end WTRU 902). If any identified upstream end WTRU is directly connected to the first relay WTRU 904, the first relay WTRU 904 may transmit the LMR message with the relay reselection indication to the identified upstream end WTRU, which may include information of initiating U2U relay (here, the second relay WTRU 906), information of the identified upstream end WTRU and a list of downstream end WTRUs whose next hop is the second relay WTRU 906 (here, the second end WTRU 912), the QoS information set of the second relay WTRU 906 for the identified upstream end WTRU (here, the first end WTRU 902) and their identified downstream peer end WTRUs that are in the included list of downstream end WTRUs (here, the second end WTRU 912), including the QoS information for the peer end WTRUs that are in the included list of downstream end WTRUs (here, the first end WTRU 902).

If any identified upstream end WTRUs are not directly connected to the first relay WTRU 904, the LMR message with the relay reselection indication received from the second relay WTRU 906 may be forwarded to each identified upstream end WTRU based on the unicast routing table hop by hop.

At the first relay WTRU 904 and each intermediate U2U relay, the received list of identified upstream end WTRUs may be split into multiple sub-lists with each sub-list including identified upstream end WTRUs associated with the same next hop and a sub-list of identified downstream end WTRUs whose next hop is the first relay WTRU 904.

At the first relay WTRU 904 and each intermediate U2U relay, the received list of the QoS information sets of the second relay WTRU 906 may be split into multiple sub-lists with each sub-list including the QoS information sets of the second relay WTRU 906 for the sub-list of identified upstream end WTRUs associated with the same next hop and their peer end WTRUs that are in the included sub-list of identified downstream end WTRUs.

At the first relay WTRU 904 and each intermediate U2U relay, each sub-list of identified upstream end WTRUs and identified downstream end WTRUs and each sub-list of the QoS information sets of the second relay WTRU 906 are transmitted in a separate LMR message with the relay reselection indication via the corresponding next hop.

The first end WTRU 902 may determine the QoS information set between the first end WTRU 902 and the second relay WTRU 906 associated with the identified peer end WTRUs of the first end WTRU 902. For end-to-end connections with the first end WTRU 902 being the source end WTRU during link establishment, the first end WTRU 902 may determine the QoS information between itself and the second relay WTRU 906 associated with each of the identified peer end WTRUs of the first end WTRU 902 based on the end-to-end QoS information for the first end WTRU 902 and each of the identified peer end WTRUs of the first end WTRU 902 and the QoS information between the second relay WTRU 906 and each of the identified peer end WTRUs of the first end WTRU 902 as received in the QoS information set of the second relay WTRU 906 for the first end WTRU 902 and the identified peer end WTRUs of the first end WTRU 902 (here, from the first relay WTRU 904).

For end-to-end connections with the first end WTRU 902 being the target end WTRU during link establishment, the first end WTRU 902 may determine the QoS information between itself and the second relay WTRU 906 associated with each of the identified peer end WTRUs of the first end WTRU 902 based on the information received in the QoS information set of the second relay WTRU 906 for the first end WTRU 902 and the identified peer end WTRUs of the first end WTRU 902 (here, from the first relay WTRU 904).

At 924, the first end WTRU 902 may perform candidate U2U relay discovery to determine a route to initiating U2U relay (here, the second relay WTRU 906, via the fourth relay WTRU 910).

At 925, the first end WTRU 902 may transmit the LER message and/or the LMR message to the fourth relay WTRU 910, which may include information of initiating U2U relay (here, the second relay WTRU 906), information of the first end WTRU 902 and a list of peer end WTRUs that are in the list of identified downstream end WTRUs received in the LMR message with the relay reselection indication (here, the second end WTRU 912). If the fourth relay WTRU 910 receives the LER message from the first end WTRU 902, the fourth relay WTRU 910 may add a route entry to the first end WTRU 902 in its unicast routing table after security establishment. If the fourth relay WTRU 910 receives the LMR message from the first end WTRU 902, the fourth relay WTRU 910 may add a route entry to the first end WTRU 902 in its unicast routing table.

At 926, the fourth relay WTRU 910 may establish security with the first end WTRU 902 if the PC5 connection between the fourth relay WTRU 910 and the first end WTRU 902 has not been established. In the security procedure after the LER message and/or in the LMR message, the first end WTRU 902 may provide the QoS information set between the first end WTRU 902 and the second relay WTRU 906 to the fourth relay WTRU 910, associated with the identified peer end WTRUs of the first end WTRU 902 (here, the second end WTRU 912).

The fourth relay WTRU 910 may determine the QoS information set between the first end WTRU 902 and the fourth relay WTRU 910 and the QoS information set between the fourth relay WTRU 910 and the second relay WTRU 906 based on the QoS information set between the first end WTRU 902 and the second relay WTRU 906, associated with the identified peer end WTRUs of the first end WTRU 902 (here, the second end WTRU 912) received from the first end WTRU 902.

At 927, the fourth relay WTRU 910 may transmit the LER message and/or the LMR message to the second relay WTRU 906, which may include information of initiating U2U relay (here, the second relay WTRU 906), information of the first end WTRU 902 and a list of identified peer end WTRUs of the first end WTRU 902 received in the LER message and/or the LMR message from the first end WTRU 902. If the second relay WTRU 906 receives the LER message from the fourth relay WTRU 910, the second relay WTRU 906 may add a route entry to the first end WTRU 902 in its unicast routing table after security establishment, with the fourth relay WTRU 910 as next hop. If the second relay WTRU 906 receives the LMR message from the fourth relay WTRU 910, the second relay WTRU 906 may add a route entry to the first end WTRU 902 in its unicast routing table, with the fourth relay WTRU 910 as next hop.

At 928, the second relay WTRU 906 may establish the security with the fourth relay WTRU 910 if the PC5 connection between the second relay WTRU 906 and the fourth relay WTRU 910 has not been established. In the security procedure after the LER message and/or in the LMR message, the fourth relay WTRU 910 may provide the QoS information set between the fourth relay WTRU 910 and the second relay WTRU 906 to the second relay WTRU 906 associated with the identified peer end WTRUs of the first end WTRU 902 (here, the second end WTRU 912) received from the first end WTRU 902.

At 929, the second relay WTRU 906 may transmit the LEA message and/or the LMA message to the fourth relay WTRU 910, which may include information of initiating U2U relay (here, the second relay WTRU 906), information of the first end WTRU 902 and a list of identified peer end WTRUs of the first end WTRU 902 (here, the second end WTRU 912), the QoS information set between the fourth relay WTRU 910 and the second relay WTRU 906, for the first end WTRU 902 and the identified peer end WTRUs of the first end WTRU 902 (here, the second end WTRU 912). The fourth relay WTRU 910 may add a route entry to each of the identified peer end WTRUs of the first end WTRU 902 in its unicast routing table, with the second relay WTRU 906 as the next hop.

At 930, the fourth relay WTRU 910 may transmit the LEA message and/or the LMA message to the first end WTRU 902, which may include information of initiating U2U relay (here, the second relay WTRU 906), information of the first end WTRU 902 and the list of identified peer end WTRUs of the first end WTRU 902 (here, the second end WTRU 912), the QoS information set between the first end WTRU 902 and the fourth relay WTRU 910, considering the received QoS information set between the fourth relay WTRU 910 and the second relay WTRU 906 from the second relay WTRU 906, for the first end WTRU 902 and the identified peer end WTRUs of the first end WTRU 902 (here, the second end WTRU 912).

The first end WTRU 902 may add a route entry to each of the identified peer end WTRUs of the first end WTRU 902 received in the LEA message and/or the LMA message in its unicast routing table, with the fourth relay WTRU 910 as the next hop. After PC5 connection setup with the fourth relay WTRU 910, the first end WTRU 902 may get the IP address from the fourth relay WTRU 910 or assign a link local IP address.

At 931, the first end WTRU 902 may transmit the LMA message with the relay reselection indication to the second relay WTRU 906, via the first relay WTRU 904, which may include information of the initiating U2U relay (here the second relay WTRU 906), information of the first end WTRU 902 and the list of identified peer end WTRUs of the first end WTRU 902 (here, the second end WTRU 912). After transmitting the LMA message with the relay reselection indication, the first end WTRU 902 may remove the corresponding original route entry (via the first relay WTRU 904) to each identified peer end WTRU in its unicast routing table. Upon receiving the LMA message with the relay reselection indication, the second relay WTRU 906 may remove the original route entry (via the first relay WTRU 904) to the first end WTRU 902 in its unicast routing table.

At 932, the first end WTRU 902 may transmit the LMN message to the list of identified peer end WTRUs of the first end WTRU 902, via the fourth relay WTRU 910, which may include information of the first end WTRU 902 and the list of identified peer end WTRUs of the first end WTRU 902 (here, the second end WTRU 912), to facilitate updating of route entry (e.g., hop count) to the first end WTRU 902 along the downstream paths to the identified peer end WTRUs of the first end WTRU 902. The LMN message may include the IP address of the first end WTRU 902. The LMN message may be forwarded to each identified peer end WTRU of the first end WTRU 902 based on the unicast routing table hop by hop. At each intermediate U2U relay, the received list of the identified peer end WTRUs of the first end WTRU 902 may be split into multiple sub-lists with each sub-list including identified peer end WTRUs of the first end WTRU 902 associated with the same next hop and sent in a separate LMN message via the corresponding next hop.

At 933, after successful connection setup between the first end WTRU 902 and the second relay WTRU 906 (here, via the fourth relay WTRU 910) and notifications to the identified peer end WTRUs of the first end WTRU 902, as well as any further Layer 3 or Layer 2 end-to-end QoS reconfiguration (as needed), the first end WTRU 902 and the second end WTRU 912 may transfer traffic via the newly selected route between the first end WTRU 902 and the second end WTRU 912 (here, [the first end WTRU 902, the fourth relay WTRU 910, the second relay WTRU 906, the third relay WTRU 908, the second end WTRU 912]).

If the first end WTRU 902 cannot find and/or determine an alternative route to the second relay WTRU 906 via candidate U2U relay discovery for a preconfigured period of time, the first end WTRU 902 may initiate negotiated local and/or end-to-end WTRU-to-WTRU relay reselection similar to FIG. 7.

The first end WTRU 902 may include a link modification failure indication and information of the associated target U2U relay (here, the second relay WTRU 906) in the LMR message with the relay reselection indication sent to the first relay WTRU 904, which may include information of a list of one or more candidate U2U relays that are accessible by the first end WTRU 902 in direct PC5 connection, a list of peer end WTRUs of the first end WTRU 902 that are routable via the first relay WTRU 904 (here, the second end WTRU 912).

The first relay WTRU 904 may transmit the LMR message with relay reselection indication to the target U2U relay associated with the link modification failure indication (here, the second relay WTRU 906), which may include information of the list of candidate U2U relays transmitted by the first end WTRU 902, a sub-list of received peer end WTRUs of the first end WTRU 902 (here, the second end WTRU 912) that are routable by the first relay WTRU 904 via the second relay WTRU 906.

When the second relay WTRU 906 receives the LMR message with the relay reselection indication with link modification failure indication from the first relay WTRU 904, the second relay WTRU 906 may transmit the LMR message with relay reselection indication to each of the next hops, which may be a directly connected peer end WTRU of the first end WTRU 902 or a U2U relay associated with one of more of the peer end WTRUs of the first end WTRU 902, including information of a list of candidate U2U relays transmitted by the first end WTRU 902, information of a directly connected peer end WTRU of the first end WTRU 902 or a next-hop U2U relays (here, the third relay WTRU 908) and its associated list of peer end WTRUs of the first end WTRU 902 (here, the second end WTRU 912) that are routable by the second relay WTRU 906 via the corresponding next-hop U2U relay (here, the third relay WTRU 908). If the next hop is a directly connected peer end WTRU of the first end WTRU 902, the receiving end WTRU may perform negotiated end-to-end WTRU-to-WTRU relay reselection with the first end WTRU 902. If the next hop is a U2U relay (here, the third relay WTRU 908), the next hop may transmit the LMR message with the relay reselection indication further downstream to each of its next hops, with each next hop being one of the peer end WTRUs of the first end WTRU 902 (here, the second end WTRU 912) or a U2U relay associated with one of more of the peer end WTRUs of the first end WTRU 902. If the next hop is an intermediate end WTRU acting as a U2U relay, this next hop may perform negotiated local WTRU-to-WTRU relay reselection with the first end WTRU 902 first before transmitting the LMR message with relay reselection indication further downstream.

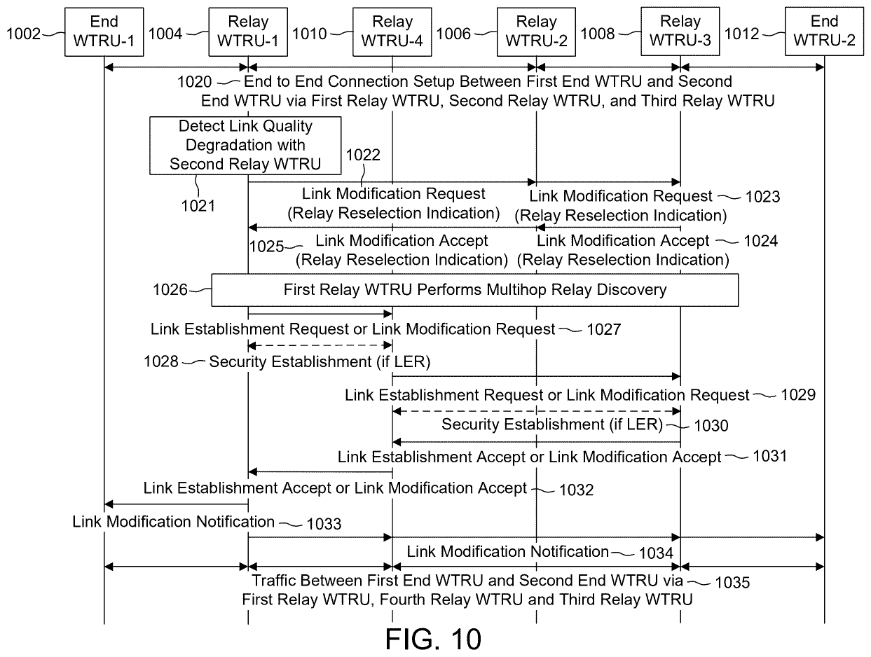

Referring now to FIG. 10, a flow diagram illustrating an example process for a soft reselection between an initiating U2U relay and a responding U2U relay with the responding U2U relay as a candidate U2U relay discoveree is shown according to one or more embodiments. The process may be used in a communication system including a first end WTRU 1002, a first relay WTRU 1004, a second relay WTRU 1006, a third relay WTRU 1008, a fourth relay WTRU 1010, and a second end WTRU 1012.

In a WTRU-to-WTRU relay mesh network, a link quality may degrade between a pair of intermediate U2U relays due to WTRU mobility and/or RF environmental changes. When this happens, it would be beneficial to have the option for the link degradation detecting U2U relay to initiate local WTRU-to-WTRU relay reselection with a responding U2U relay to circumvent the degraded link without changing the remaining parts of the end-to-end routes between each pair of (upstream and downstream) end WTRUs originally routed through the degraded link (here, the first end WTRU 1002 and the second end WTRU 1012), before resorting to the end-to-end WTRU-to-WTRU relay reselection.

In various embodiments, the present disclosure provides a local WTRU-to-WTRU relay soft reselection procedure to facilitate the (initiating) link degradation detecting U2U relay (here, the first relay WTRU 1004) to perform candidate WTRU-to-WTRU relay discovery to discover an alternative route to each responding next hop (here, the third relay WTRU 1008) of the degraded link peer U2U relay (here, the second relay WTRU 1006) that knows an active route to any of the further downstream end WTRUs originally routed through the degraded link (here, the second end WTRU 1012).

At 1020, the first end WTRU 1002 and the second end WTRU 1012 may set up hop-by-hop PC5 connections via the first relay WTRU 1004, the second relay WTRU 1006 and the third relay WTRU 1008 for end-to-end communication between the first end WTRU 1002 and the second end WTRU 1012, and the first end WTRU 1002 and the second end WTRU 1012 may exchange data traffic via the first relay WTRU 1004, the second relay WTRU 1006 and the third relay WTRU 1008. The first end WTRU 1002, the second end WTRU 1012, the first relay WTRU 1004, the second relay WTRU 1006, the third relay WTRU 1008, and the fourth relay WTRU 1010 are provisioned with the discovery security materials associated with the authorized RSC. The first end WTRU 1002, the second end WTRU 1012, and the first relay WTRU 1004 (an intermediate end WTRU acting as a U2U relay) are provisioned with the direct discovery security materials (i.e., discovery security materials associated with a prose direct discovery service for restricted prose direct discovery).

At 1021, the first relay WTRU 1004 may detect a link quality degradation between the first relay WTRU 1004 and the second relay WTRU 1006.

At 1022, the first relay WTRU 1004 may transmit a LMR message with a relay reselection indication to the second relay WTRU 1006, which may include information of initiating U2U relay (here, the first relay WTRU 1004), information of a list of downstream end WTRUs whose next hop is the second relay WTRU 1006 (here, the second end WTRU 1012).

At 1023, the second relay WTRU 1006 may transmit the LMR message with the relay reselection indication to each next hop (here, the third relay WTRU 1008) associated with a sub-list of downstream end WTRUs received from the first relay WTRU 1004 (here, the second end WTRU 1012), which may include information of initiating U2U relay (here, the first relay WTRU 1004), information of a sub-list of downstream end WTRUs received from the first relay WTRU 1004 (here, the second end WTRU 1012) associated with each next hop (here, the third relay WTRU 1008) and a list of upstream end WTRUs whose next hop is the first relay WTRU 1004 (here, the second end WTRU 1012).

At 1024, the third relay WTRU 1008 may transmit the LMA message with the relay reselection indication to the second relay WTRU 1006, which may include information of initiating U2U relay (here, the first relay WTRU 1004) and responding U2U relay (here, the third relay WTRU 1008), information of a sub-list of upstream end WTRUs received from the second relay WTRU 1006 that are routable via the third relay WTRU 1008 (here, the first end WTRU 1002) and a list of identified downstream end WTRUs received from the second relay WTRU 1006 (here, the second end WTRU 1012), a list of the QoS information sets of the third relay WTRU 1008 for the list of the identified downstream end WTRUs (here, the second end WTRU 1012) and their identified upstream peer end WTRUs (here, the first end WTRU 1002), including the QoS information for the peer end WTRUs that are in the included list of upstream end WTRUs (here, the first end WTRU 1002). The QoS information set of third relay WTRU 1008 for the second end WTRU 1012 and the identified peer end WTRUs of the second end WTRU 1012 (here, the first end WTRU 1002) includes, for end-to-end connections with the second end WTRU 1012 being the source end WTRU in the QoS context of the unicast routing table of the third relay WTRU 1008, the QoS information between the third relay WTRU 1008 and each peer target end WTRUs of the second end WTRU 1012 that is in the list of identified upstream end WTRUs (here, the first end WTRU 1002) based on the information in the QoS context. The QoS information set may include, for end-to-end connections with the second end WTRU 1012 being the target end WTRU in the QoS context of the unicast routing table of the third relay WTRU 1008, the QoS information between the third relay WTRU 1008 and the second end WTRU 1012 associated with each of peer source end WTRUs of the second end WTRU 1012 that is in the list of identified upstream end WTRUs (here, the first end WTRU 1002) based on the information in the QoS context.

At 1025, the second relay WTRU 1006 may transmit the LMA message with the relay reselection indication to the first relay WTRU 1004, which may include information of the initiating U2U relay (here, the first relay WTRU 1004) and the responding U2U relay (here, the third relay WTRU 1008), information of a list of identified upstream end WTRUs received from the third relay WTRU 1008 (here, the first end WTRU 1002) and a list of identified downstream end WTRUs received from the third relay WTRU 1008 (here, the second end WTRU 1012), a list of the QoS information sets of the third relay WTRU 1008 for the list of identified downstream end WTRUs (here, the second end WTRU 1012) and their peer end WTRUs (here, the first end WTRU 1002) that are in the list of identified upstream end WTRUs received from the third relay WTRU 1008 (here, the first end WTRU 1002).

The first relay WTRU 1004 may determine the QoS information set between the first relay WTRU 1004 and the third relay WTRU 1008 for the second end WTRU 1012 and the identified peer end WTRUs of the second end WTRU 1012 (here, the first end WTRU 1002). In that, for end-to-end connections with the second end WTRU 1012 being the source end WTRU in the QoS context of the unicast routing table of the first relay WTRU 1004, the first relay WTRU 1004 may determine the QoS information between the first relay WTRU 1004 and the third relay WTRU 1008 based on the QoS information the between the third relay WTRU 1008 and each of the identified peer target end WTRUs of the second end WTRU 1012 as received in the QoS information set of the third relay WTRU 1008 for the second end WTRU 1012 and the identified peer end WTRUs of the second end WTRU 1012 from the second relay WTRU 1006, and the QoS information between the first relay WTRU 1004 and each of the identified peer target end WTRUs of the second end WTRU 1012 in the QoS context of the first relay WTRU 1004. Further, for end-to-end connections with the second end WTRU 1012 being the target end WTRU in the QoS context of the unicast routing table of the first relay WTRU 1004, the first relay WTRU 1004 may determine the QoS information between the first relay WTRU 1004 and the third relay WTRU 1008 based on the QoS information the between the third relay WTRU 1008 and the second end WTRU 1012 as received in the QoS information set of the third relay WTRU 1008 for the second end WTRU 1012 and the identified peer end WTRUs of the second end WTRU 1012 from the second relay WTRU 1006, and the QoS information between the first relay WTRU 1004 and the second end WTRU 1012 in the QoS context of the first relay WTRU 1004, associated with each of the identified peer source end WTRUs of the second end WTRU 1012 in the QoS context of the first relay WTRU 1004.

At 1026, the first relay WTRU 1004 may perform candidate U2U relay discovery to find and/or determine an alternative route to the third relay WTRU 1008 (here, via the fourth relay WTRU 1010).

At 1027, the first relay WTRU 1004 may transmit the LER message and/or the LMR message to the fourth relay WTRU 1010, which may include information of initiating U2U relay (here, the first relay WTRU 1004) and responding U2U relay (here, the third relay WTRU 1008), information of the list of identified upstream end WTRUs (here, the first end WTRU 1002) and the list of identified downstream end WTRUs (here, the second end WTRU 1012) received from the second relay WTRU 1006. If the fourth relay WTRU 1010 receives the LER message from the first relay WTRU 1004, the fourth relay WTRU 1010 may add a route entry to each identified upstream end WTRU in its unicast routing table after security establishment, with the first relay WTRU 1004 as next hop. If the fourth relay WTRU 1010 receives the LMR message from the first relay WTRU 1004, the fourth relay WTRU 1010 may add a route entry to each identified upstream end WTRU in its unicast routing table, with the first relay WTRU 1004 as next hop.

At 1028, the fourth relay WTRU 1010 may establish security with the first relay WTRU 1004 if the PC5 connection between the fourth relay WTRU 1010 and the first relay WTRU 1004 has not been established. In the security procedure after the LER message and/or in the LMR message, the first relay WTRU 1004 may provide the list of QoS information sets between the first relay WTRU 1004 and the third relay WTRU 1008 to the fourth relay WTRU 1010, for the list of identified downstream end WTRUs (here, the second end WTRU 1012) received from the second relay WTRU 1006 and their identified peer end WTRUs that are in the list of the identified upstream end WTRUs (here, the first end WTRU 1002) received from the second relay WTRU 1006. The fourth relay WTRU 1010 may determine a list of the QoS information sets between the first relay WTRU 1004 and the fourth relay WTRU 1010 and a list of the QoS information sets between the fourth relay WTRU 1010 and the third relay WTRU 1008 based on the list of QoS information sets between the first relay WTRU 1004 and the third relay WTRU 1008, for the list of identified downstream end WTRUs (here, the second end WTRU 1012) and their identified upstream peer end WTRUs (here, the first end WTRU 1002) received from the first relay WTRU 1004.

At 1029, the fourth relay WTRU 1010 may transmit the LER message and/or the LMR message to the third relay WTRU 1008, which may include information of initiating U2U relay (here, the first relay WTRU 1004) and responding U2U relay (here, the third relay WTRU 1008), information of the list of identified upstream end WTRUs (here, the first end WTRU 1002) and the list of identified downstream end WTRUs (here, the second end WTRU 1012) received in the LER message and/or the LMR message from the first relay WTRU 1004. If the third relay WTRU 1008 receives the LER message from the fourth relay WTRU 1010, the third relay WTRU 1008 may add a route entry to each identified upstream end WTRU received from the fourth relay WTRU 1010 (here, the first end WTRU 1002) in its unicast routing table after security establishment, with the fourth relay WTRU 1010 as next hop. If the third relay WTRU 1008 receives the LMR message from the fourth relay WTRU 1010, the third relay WTRU 1008 may add a route entry to each identified upstream end WTRU received from the fourth relay WTRU 1010 (here, the first end WTRU 1002) in its unicast routing table, with the fourth relay WTRU 1010 as next hop.

At 1030, the third relay WTRU 1008 may establish security with the fourth relay WTRU 1010 if the PC5 connection between the third relay WTRU 1008 and the fourth relay WTRU 1010 has not been established. In the security procedure after the LER message and/or in the LMR message, the fourth relay WTRU 1010 provides the list of QoS information sets between the fourth relay WTRU 1010 and the third relay WTRU 1008 for the list of identified downstream end WTRUs (here, the second end WTRU 1012) and their identified upstream peer end WTRUs (here, the first end WTRU 1002) to the third relay WTRU 1008.

At 1031, the third relay WTRU 1008 may transmit the LEA message and/or the LMA message to the fourth relay WTRU 1010, which may include the information of initiating and responding U2U relays (here, the first relay WTRU 1004 and the third relay WTRU 1008), the information of the list of identified upstream end WTRUs (here, the first end WTRU 1002) and the list of identified downstream end WTRUs (here, the second end WTRU 1012), the list of QoS information sets between the fourth relay WTRU 1010 and the third relay WTRU 1008 for the list of identified downstream end WTRUs (here, the second end WTRU 1012) and their identified upstream peer end WTRUs (here, the first end WTRU 1002). The fourth relay WTRU 1010 may add a route entry to each of the identified downstream end WTRUs received from the third relay WTRU 1008 in its unicast routing table, with the third relay WTRU 1008 as next hop.

At 1032, the fourth relay WTRU 1010 may transmit the LEA message and/or the LMA message to the first relay WTRU 1004, which may include information of initiating U2U relay (here, the first relay WTRU 1004) and responding U2U relay (here, the third relay WTRU 1008), information of the list of identified upstream end WTRUs (here, the first end WTRU 1002) and the list of identified downstream end WTRUs (here, the second end WTRU 1012), the list of QoS information sets between the first relay WTRU 1004 and the fourth relay WTRU 1010, considering the list of QoS information sets between the fourth relay WTRU 1010 and the third relay WTRU 1008 received from the third relay WTRU 1008, for the list of identified downstream end WTRUs (here, the second end WTRU 1012) and their identified upstream peer end WTRUs (here, the first end WTRU 1002).

The first relay WTRU 1004 may add a route entry to each of the identified downstream end WTRUs received from the fourth relay WTRU 1010 in its unicast routing table, with the fourth relay WTRU 1010 as next hop, and may remove the corresponding original route entry (via the second relay WTRU 1006).

At 1033, the first relay WTRU 1004 may transmit one or more LMN messages to the list of identified upstream end WTRUs, which may include information of the list of identified upstream end WTRUs (here, the first end WTRU 1002) and the list of identified downstream end WTRUs (here, the second end WTRU 1012) received in the LEA message and/or the LMA message from the fourth relay WTRU 1010 to facilitate updating of the route entries (e.g., hop counts) to downstream end WTRUs along the upstream paths.

The LMN messages may be forwarded to each identified upstream end WTRU based on the unicast routing table hop by hop. At each intermediate U2U relay, the received list of identified upstream end WTRUs may be split into multiple sub-lists with each sub-list including identified upstream end WTRUs associated with the same next hop, and transmitted in a separate LMN message via the corresponding next hop.

At 1034, the first relay WTRU 1004 may transmit one or more LMN messages, via the fourth relay WTRU 1010, to the identified downstream end WTRUs, which may include information of a list of identified downstream end WTRUs (here, the second end WTRU 1012) and a list of identified upstream end WTRUs (here, the first end WTRU 1002) received in the LEA message and/or the LMA message from the fourth relay WTRU 1010 to facilitate updating of route entries (e.g., hop counts) to the identified upstream end WTRUs along the downstream paths.

The link LMN messages may be forwarded to each identified downstream end WTRU based on the unicast routing table hop by hop. At each intermediate U2U relay, the received list of identified downstream end WTRUs may be split into multiple sub-lists with each sub-list including identified downstream end WTRUs associated with the same next hop, and transmitted in a separate LMN message via the corresponding next hop. In addition, in each hop of a notification path, the relay WTRU only includes the sub-list of the identified upstream end WTRUs that are routable via this hop before transmitting the LMN message to the next hop.

Upon receiving the LMN message from the fourth relay WTRU 1010, the third relay WTRU 1008 may remove the original route entry (via the second relay WTRU 1006) to each identified upstream end WTRU (here, the second end WTRU 1012).

At 1035, after successful connection setup between the first relay WTRU 1004 and the third relay WTRU 1008 (here, via the fourth relay WTRU 1010) and notifications to the identified upstream and downstream end WTRUs, as well as any further Layer 3 and/or Layer 2 end-to-end QoS reconfiguration (as needed), the first end WTRU 1002 and the second end WTRU 1012 may transfer traffic via the newly selected route between the first end WTRU 1002 and the second end WTRU 1012 (here, [the first end WTRU 1002, the first relay WTRU 1004, the fourth relay WTRU 1010, the third relay WTRU 1008, the second end WTRU 1012]).

If the first relay WTRU 1004 cannot find and/or determine an alternative route to the third relay WTRU 1008 via candidate WTRU-to-WTRU relay discovery for a preconfigured period of time, the first relay WTRU 1004 may transmit a link quality degradation notification to the upstream end WTRUs received in the LMA message with the relay reselection indication (here, the first end WTRU 1002), which may include information of the third relay WTRU 1008 and the associated downstream end WTRUs in the received the LMA message with relay reselection indication, for the notified upstream end WTRUs to initiate negotiated end-to-end WTRU-to-WTRU relay reselection with their peer end WTRUs that are in the received list of downstream end WTRUs (here, the second end WTRU 1012).

The link quality degradation notification may be forwarded to the identified upstream end WTRUs based on the unicast routing table hop by hop. At each intermediate U2U relay, the received list of identified upstream end WTRUs may be split into multiple sub-lists with each sub-list including identified upstream end WTRUs associated with the same next hop, and transmitted in a separate link quality degradation notification via the corresponding next hop. In addition, in each hop of a notification path, the U2U relay only includes the sub-list of downstream end WTRUs that are routable via this hop before transmitting the link quality degradation notification to the next hop. An intermediate end WTRU acting as a U2U relay along the notification path may also initiate a candidate WTRU-to-WTRU relay discovery to find and/or determine a route to the third relay WTRU 1008 before transmitting the link quality degradation notification further upstream.

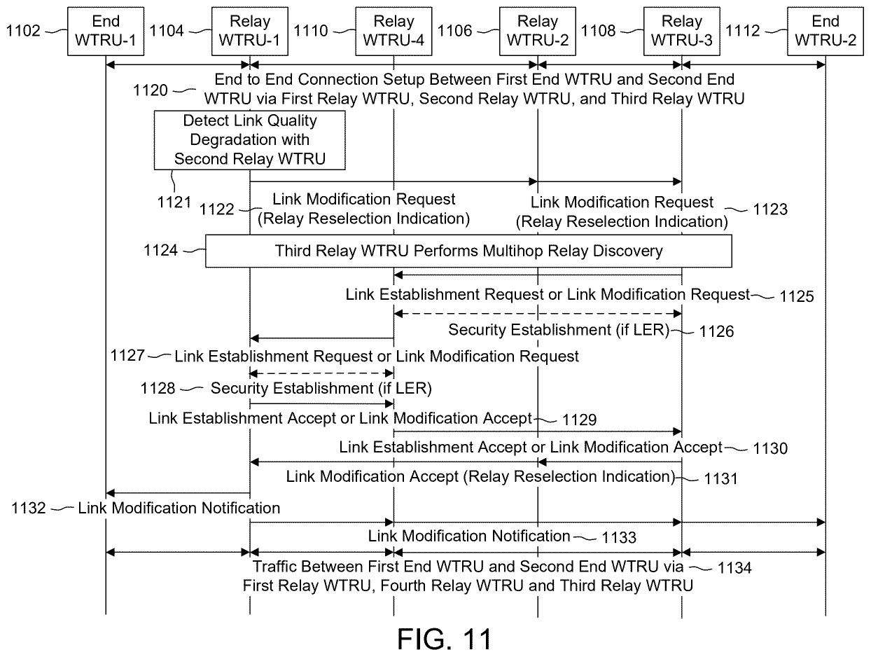

Referring now to FIG. 11, a flow diagram illustrating an example process for a soft reselection between an initiating U2U relay and a responding U2U relay with the initiating U2U relay as a candidate U2U relay discoveree is shown according to one or more embodiments. The process may be used in a communication system including a first end WTRU 1102, a first relay WTRU 1104, a second relay WTRU 1106, a third relay WTRU 1108, a fourth relay WTRU 1110, and a second end WTRU 1112.

In a WTRU-to-WTRU relay mesh network, a link quality may degrade between a pair of intermediate U2U relays due to WTRU mobility and/or RF environmental changes. When this happens, it would be beneficial to have the option for the link degradation detecting U2U relay to initiate local WTRU-to-WTRU relay reselection with a responding U2U relay to circumvent the degraded link without changing the remaining parts of the end-to-end routes between each pair of (upstream and downstream) the end WTRUs originally routed through the degraded link (here, the first end WTRU 1102 and the second end WTRU 1112), before resorting to the end-to-end WTRU-to-WTRU relay reselection.

In various embodiments, the present disclosure provides a local WTRU-to-WTRU relay soft reselection procedure for the (initiating) link degradation detecting U2U relay (here, the first relay WTRU 1104) to indicate to a responding intermediate end WTRU acting as a U2U relay (here, the third relay WTRU 1108) beyond the peer U2U relay of the degraded link (here, the second relay WTRU 1106) that knows an active route to any of the further downstream end WTRUs originally routed through the degraded link (here, the second end WTRU 1112) to perform candidate WTRU-to-WTRU relay discovery to discover an alternative route to the initiating U2U relay (here, the first relay WTRU 1104).

At 1120, the first end WTRU 1102 and the second end WTRU 1112 may set up hop-by-hop PC5 connections via the first relay WTRU 1104, the second relay WTRU 1106 and the third relay WTRU 1108 for end-to-end communication between the first end WTRU 1102 and the second end WTRU 1112, and the first end WTRU 1102 and the second end WTRU 1112 exchange data traffic via the first relay WTRU 1104, the second relay WTRU 1106 and the third relay WTRU 1108.

The first end WTRU 1102, the second end WTRU 1112, the first relay WTRU 1104, the second relay WTRU 1106, the third relay WTRU 1108e, and the fourth relay WTRU 1110 are provisioned with the discovery security materials associated with the authorized RSC.

The first end WTRU 1102, the second end WTRU 1112, and the third relay WTRU 1108 (an intermediate the end WTRU acting as a U2U relay) are provisioned with the direct discovery security materials (i.e., discovery security materials associated with a prose direct discovery service for restricted prose direct discovery).

At 1121, the first relay WTRU 1104 may detect a link quality degradation between the first relay WTRU 1104 and the second relay WTRU 1106.

At 1122, the first relay WTRU 1104 may transmit a LMR message with a relay reselection indication to the second relay WTRU 1106, which may include information of initiating U2U relay (here, the first relay WTRU 1104), information of a list of downstream end WTRUs whose next hop is the second relay WTRU 1106 (here, the second end WTRU 1112), a list of the QoS information sets of the first relay WTRU 1104 for the list of identified downstream end WTRUs (here, the second end WTRU 1112) and their identified upstream peer end WTRUs (here, the first end WTRU 1102). For example, the QoS information set of the first relay WTRU 1104 for the second end WTRU 1112 and the identified peer end WTRUs of the second end WTRU 1112 (here, the first end WTRU 1102) includes, for end-to-end connections with the second end WTRU 1112 being the source end WTRU in the QoS context of the unicast routing table of the first relay WTRU 1104, the QoS information between the first relay WTRU 1104 and each of the peer target end WTRUs of the second end WTRU 1112 (here, the first end WTRU 1102) based on the information in the QoS context. For end-to-end connections with the second end WTRU 1112 being the target end WTRU in the QoS context of the unicast routing table of the first relay WTRU 1104, the QoS information between the first relay WTRU 1104 and the second end WTRU 1112 associated with each of the peer source end WTRUs of the second end WTRU 1112 (here, the first end WTRU 1102) based on the information in the QoS context.

At 1123, the second relay WTRU 1106 may transmit a LMR message with relay reselection indication to each next hop (here, the third relay WTRU 1108) associated with a sub-list of downstream end WTRUs received from the first relay WTRU 1104 (here, the second end WTRU 1112), which may include information of initiating U2U relay (here, the first relay WTRU 1104), information of a sub-list of downstream end WTRUs (here, the second end WTRU 1112) associated with each next hop (here, the third relay WTRU 1108) and a list of identified upstream end WTRUs whose next hop is the first relay WTRU 1104 (here, the first end WTRU 1102), a list of the QoS information sets of the first relay WTRU 1104 for the sub-list of identified downstream end WTRUs (here, the second end WTRU 1112) and their identified upstream peer end WTRUs (here, the first end WTRU 1102), including the QoS information associated with their peer end WTRUs that are in the list of identified upstream end WTRUs (here, the first end WTRU 1102).

The third relay WTRU 1108 may determine a sub-list of identified upstream end WTRUs received from the second relay WTRU 1106, that are routable by the third relay WTRU 1108 (here, the first end WTRU 1102) and a list of the QoS information sets between the third relay WTRU 1108 and the first relay WTRU 1104 for the list of identified downstream end WTRUs received from the second relay WTRU 1106 (here, the second end WTRU 1112) and their identified upstream peer end WTRUs (here, the first end WTRU 1102), including QoS information associated with their peer end WTRUs that are in the sub-list of identified upstream end WTRUs received from the second relay WTRU 1106 that are routable by the third relay WTRU 1108.

The third relay WTRU 1108 may determine the list of QoS information sets between the third relay WTRU 1108 and the first relay WTRU 1104 for the list of identified downstream end WTRUs (here, the second end WTRU 1112) and their identified upstream peer end WTRUs (here, the first end WTRU 1102). For example, the third relay WTRU 1108 may determine the QoS information set between the third relay WTRU 1108 and the first relay WTRU 1104 for the second end WTRU 1112 and the identified peer end WTRUs of the second end WTRU 1112 (here, the first end WTRU 1102) that are in the sub-list of identified upstream end WTRUs received from the second relay WTRU 1106 that are routable by the third relay WTRU 1108. In that, for end-to-end connections with the second end WTRU 1112 being the source end WTRU in the QoS context of the unicast routing table of the third relay WTRU 1108, the third relay WTRU 1108 may determine the QoS information between the third relay WTRU 1108 and the first relay WTRU 1104 for the second end WTRU 1112 and each of the identified peer target end WTRUs of the second end WTRU 1112 (here, the first end WTRU 1102) based on the QoS information the between the first relay WTRU 1104 and each of the identified peer target end WTRUs of the second end WTRU 1112 that is in the sub-list of identified upstream end WTRUs of the third relay WTRU 1108 using a subset of information in the QoS information set of the first relay WTRU 1104 received from the second relay WTRU 1106, and the QoS information between the third relay WTRU 1108 and each of the identified peer target end WTRUs of the second end WTRU 1112 in the QoS context of the third relay WTRU 1108. Further, for end-to-end connections with the second end WTRU 1112 being the target end WTRU in the QoS context of the unicast routing table of the third relay WTRU 1108, the third relay WTRU 1108 may determine the QoS information between the third relay WTRU 1108 and the first relay WTRU 1104 for the second end WTRU 1112 and each of the identified peer source end WTRUs of the second end WTRU 1112 (here, the first end WTRU 1102), based on the QoS information between the first relay WTRU 1104 and the second end WTRU 1112 as received in the QoS information set from the second relay WTRU 1106 and the QoS information between the third relay WTRU 1108 and the second end WTRU 1112 in the QoS context of the third relay WTRU 1108, associated with each of the identified peer source end WTRUs of the second end WTRU 1112 (here, the first end WTRU 1102) in the QoS context of the third relay WTRU 1108.

At 1124, the third relay WTRU 1108 (the first intermediate the end WTRU acting as a U2U relay along the path to any of downstream end WTRUs) may perform candidate U2U relay discovery to find and/or determine a route to the first relay WTRU 1104 (here, via the fourth relay WTRU 1110).

At 1125, the third relay WTRU 1108 may transmit the LER message and/or the LMR message to the fourth relay WTRU 1110, which may include information of initiating U2U relay (here, the first relay WTRU 1104) and responding U2U relay (here, the third relay WTRU 1108), information of a list of identified downstream end WTRUs received from the second relay WTRU 1106 and a sub-list of identified upstream end WTRUs received from the second relay WTRU 1106 that are routable by the third relay WTRU 1108 (here, the first end WTRU 1102). If the fourth relay WTRU 1110 receives the LER message from the third relay WTRU 1108, the fourth relay WTRU 1110 may add a route entry to each identified downstream end WTRU received from the third relay WTRU 1108 (here, the second end WTRU 1112) in its unicast routing table after security establishment, with the third relay WTRU 1108 as next hop. If the fourth relay WTRU 1110 receives the LMR message from the third relay WTRU 1108, the fourth relay WTRU 1110 may add a route entry to each identified downstream end WTRU received from the third relay WTRU 1108 (here, the second end WTRU 1112) in its unicast routing table, with the third relay WTRU 1108 as next hop.

At 1126, the fourth relay WTRU 1110 may establish security with the third relay WTRU 1108 if the PC5 connection between the fourth relay WTRU 1110 and the third relay WTRU 1108 has not been established. In the security procedure after the LER message and/or in the LMR message, the third relay WTRU 1108 may provide the list of QoS information sets between the third relay WTRU 1108 and the first relay WTRU 1104 for the list of identified downstream end WTRUs (here, the second end WTRU 1112) and their identified upstream peer end WTRUs (here, the first end WTRU 1102) to the fourth relay WTRU 1110. The fourth relay WTRU 1110 may determine the list of QoS information sets between the third relay WTRU 1108 and the fourth relay WTRU 1110 and the list of QoS information set between the fourth relay WTRU 1110 and the first relay WTRU 1104 based on the list of QoS information set between the third relay WTRU 1108 and the first relay WTRU 1104, for the list of identified downstream end WTRUs (here, the second end WTRU 1112) and their identified upstream peer end WTRUs (here, the first end WTRU 1102).

At 1127, the fourth relay WTRU 1110 may transmit the LER message and/or the LMR message to the first relay WTRU 1104, which may include information of initiating U2U relay (here, the first relay WTRU 1104) and responding U2U relay (here, the third relay WTRU 1108), information of a list of identified downstream end WTRUs and the list of identified upstream end WTRUs received from the third relay WTRU 1108. If the first relay WTRU 1104 receives the LER message from the fourth relay WTRU 1110, the first relay WTRU 1104 may add a route entry to each identified downstream end WTRU received from the fourth relay WTRU 1110 (here, the second end WTRU 1112) in its unicast routing table after security establishment, with the fourth relay WTRU 1110 as next hop. If the first relay WTRU 1104 receives the LMR message from the fourth relay WTRU 1110, the first relay WTRU 1104 may add a route entry to each identified downstream end WTRU received from the fourth relay WTRU 1110 (here, the second end WTRU 1112) in its unicast routing table, with the fourth relay WTRU 1110 as next hop.

At 1128, the first relay WTRU 1104 may establish security with the fourth relay WTRU 1110 if the PC5 connection between the first relay WTRU 1104 and the fourth relay WTRU 1110 has not been established. In the security procedure after the LER message and/or in the LMR message, the fourth relay WTRU 1110 may provide the list of QoS information sets between the fourth relay WTRU 1110 and the first relay WTRU 1104 to the first relay WTRU 1104, for the list of identified downstream end WTRUs (here, the second end WTRU 1112) and their identified upstream peer end WTRUs (here, the first end WTRU 1102).

At 1129, the first relay WTRU 1104 may transmit the LEA message and/or the LMA message to the fourth relay WTRU 1110, which may include information of initiating U2U relay (here, the first relay WTRU 1104) and responding U2U relay (here, the third relay WTRU 1108), information of the list of identified downstream end WTRUs and the list of identified upstream end WTRUs received from the fourth relay WTRU 1110, the list of QoS information sets between the fourth relay WTRU 1110 and the first relay WTRU 1104 for the list of identified downstream end WTRUs (here, the second end WTRU 1112) and their identified upstream peer end WTRUs (here, the first end WTRU 1102). The fourth relay WTRU 1110 may add a route entry to each identified upstream end WTRU (here, the first end WTRU 1102) in its unicast routing table, with the first relay WTRU 1104 as next hop.

At 1130, the fourth relay WTRU 1110 may transmit the LEA message and/or the LMA message to the third relay WTRU 1108, which may include information of initiating U2U relay (here, the first relay WTRU 1104) and responding U2U relay (here, the third relay WTRU 1108), information of the list of identified downstream end WTRUs and the list of identified upstream end WTRUs, the list of QoS information sets between the third relay WTRU 1108 and the fourth relay WTRU 1110, considering the list of QoS information sets between the fourth relay WTRU 1110 and the first relay WTRU 1104 from received the first relay WTRU 1104, for the list of identified downstream end WTRUs (here, the second end WTRU 1112) and their identified upstream peer end WTRUs (here, the first end WTRU 1102). The third relay WTRU 1108 may add a route entry to each of the identified upstream end WTRUs (here, the first end WTRU 1102) in its unicast routing table, with the fourth relay WTRU 1110 as next hop.

At 1131, the third relay WTRU 1108 may transmit the LMA message with the relay reselection indication to the first relay WTRU 1104, via the second relay WTRU 1106, which may include information of initiating U2U relay (here, the first relay WTRU 1104e) and responding U2U relay (here, the third relay WTRU 1108), information of the list of identified downstream end WTRUs and the list of identified upstream end WTRUs. Upon receiving the LMA message with the relay reselection indication, the first relay WTRU 1104 may remove the original route entry (via the second relay WTRU 1106) to each of the identified downstream end WTRUs in its unicast routing table.

At 1132, the first relay WTRU 1104 may transmit the LMN message to the list of identified upstream end WTRUs, which may include information of the list of identified upstream end WTRUs (here, the first end WTRU 1102) and the list of identified downstream end WTRUs to facilitate updating of route entries (e.g., hop counts) to the identified downstream end WTRUs along the upstream paths. The LMN message may be forwarded to each identified upstream end WTRU based on the unicast routing table hop by hop. At each intermediate U2U relay, the received list of identified upstream end WTRUs may be split into multiple sub-lists with each sub-list including identified upstream end WTRUs associated with the same next hop, and transmitted in a separate LMN message via the corresponding next hop. In addition, in each hop of a notification path, the relay WTRU only includes the sub-list of the identified downstream end WTRUs that are routable via this hop before transmitting the LMN message to the next hop.

At 1133, the first relay WTRU 1104 may transmit the LMN message, via the fourth relay WTRU 1110, to the list of identified downstream end WTRUs, which may include information of the list of identified downstream end WTRUs and the list of identified upstream end WTRUs to facilitate updating of the route entries (e.g., hop counts) to the identified upstream end WTRUs along the downstream paths. The LMN message may be forwarded to each identified downstream end WTRU based on the unicast routing table hop by hop. At each intermediate U2U relay, the received list of identified downstream end WTRUs may be split into multiple sub-lists with each sub-list including identified downstream end WTRUs associated with the same next hop, and sent in a separate LMN message via the corresponding next hop. In addition, in each hop of a notification path, the relay WTRU only includes the sub-list of the identified upstream end WTRUs that are routable via this hop before transmitting the LMN message to the next hop. Upon receiving the LMN message, the third relay WTRU 1108 may remove the original route entry (via the second relay WTRU 1106) to each of the identified upstream end WTRUs (here, the first end WTRU 1102).

At 1134, after successful connection setup between the first relay WTRU 1104 and the third relay WTRU 1108 (here, via the fourth relay WTRU 1110) and notifications to the identified upstream and downstream end WTRUs, as well as any further Layer 3 and/or Layer 2 end-to-end QoS reconfiguration (as needed), the first end WTRU 1102 and the second end WTRU 1112 may transfer traffic via the newly selected route between the first end WTRU 1102 and the second end WTRU 1112 (here, [the first end WTRU 1102, the first relay WTRU 1104, the fourth relay WTRU 1110, the third relay WTRU 1108, the second end WTRU 1112]).

If the third relay WTRU 1108 cannot find and/or determine an alternative route to the first relay WTRU 1104 via candidate WTRU-to-WTRU relay discovery for a preconfigured period of time, the third relay WTRU 1108 may transmit a link quality degradation notification to the downstream end WTRUs received in the LMR message with the relay reselection indication (here, the second end WTRU 1112), which may include information of the first relay WTRU 1104 and the list of identified upstream end WTRUs, for the notified downstream end WTRUs to initiate negotiated end-to-end WTRU-to-WTRU relay reselection with their peer end WTRUs that are in the received list of upstream end WTRUs (here, the first end WTRU 1102). The link quality degradation notification may be forwarded to the identified downstream end WTRUs based on the unicast routing table hop-by-hop. At each intermediate U2U relay, the received list of identified downstream end WTRUs may be split into multiple sub-lists with each sub-list including identified downstream end WTRUs associated with the same next hop, and transmitted in a separate link quality degradation notification via the corresponding next hop. In addition, in each hop of a notification path, the U2U relay only includes the sub-list of upstream end WTRUs that are routable via this hop before transmitting the link quality degradation notification to the next hop. An intermediate end WTRU acting as a U2U relay along the notification path may also initiate the candidate WTRU-to-WTRU relay discovery to find and/or determine a route to the first relay WTRU 1104 before transmitting the link quality degradation notification further downstream.

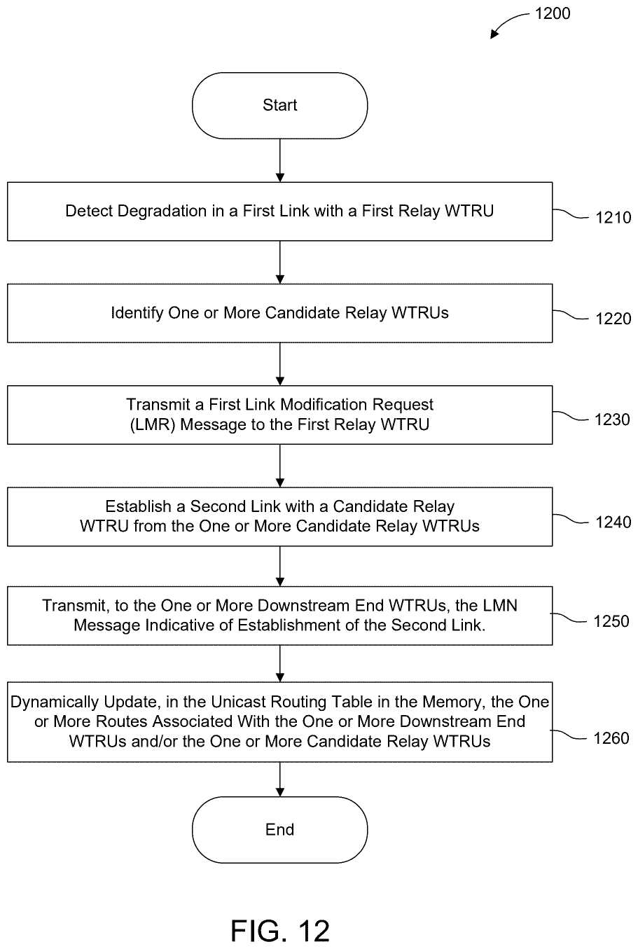

Referring to FIG. 12, a flowchart illustrating an example process 1200 for soft relay reselection is shown according to one or more embodiments. The process 1200 is performed by a first end WTRU.

At 1210, the first end WTRU detects degradation in the first link with the first relay WTRU. The first link connects to the one or more downstream end WTRUs via the first relay WTRU.

At 1220, the first end WTRU identifies the one or more candidate relay WTRUs.

At 1230, the first end WTRU transmits the first LMR message to the first relay WTRU. The first LMR message is indicative of the relay reselection indication and/or the one or more candidate relay WTRUs. The first LMR message is further indicative of the one or more identities of the one or more downstream end WTRUs routable via the first relay WTRU and/or the an end-to-end QoS information set associated with the one or more downstream peer end WTRUs of the first end WTRU.

At 1240, the first end WTRU establishes a second link with a candidate relay WTRU from the one or more candidate relay WTRUs. The first end WTRU receives the LER message and/or a second LMR message from the candidate relay WTRU. The first end WTRU transmits the LEA message and/or the second LMA message to the candidate relay WTRU in response to the LER message and/or the second LMR message. The first end WTRU receives the first LMA message from the first relay WTRU. The first LMA message is indicative of the relay reselection indication and/or an acknowledgement of establishment of the second link.

At 1250, the first end WTRU transmits the LMN message to the one or more downstream end WTRUs. The LMN message is indicative of establishment of the second link.

At 1260, the first end WTRU dynamically updates, in the unicast routing table in the memory, the one or more routes associated with the one or more downstream end WTRUs and/or the one or more candidate relay WTRUs.

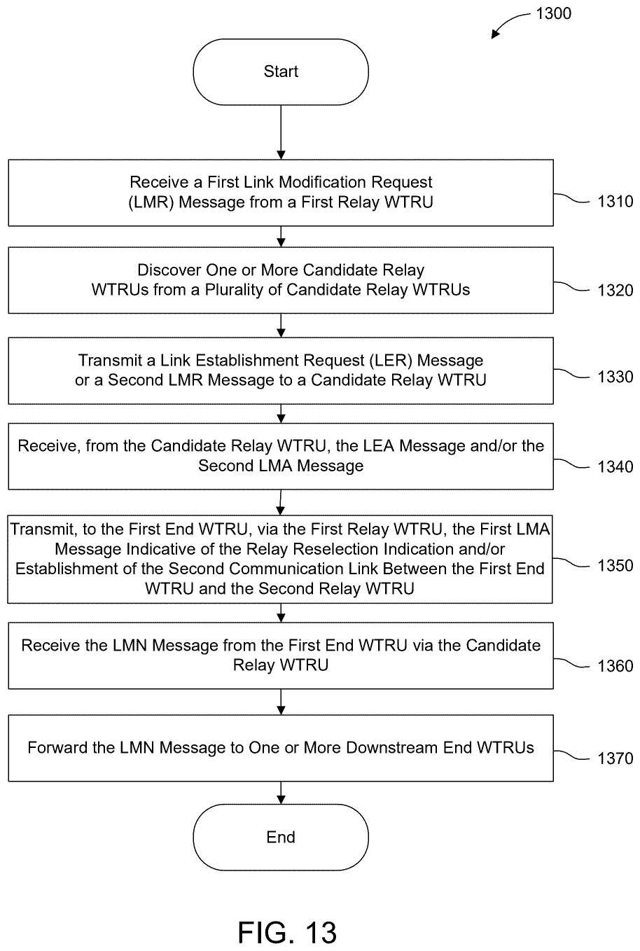

Referring to FIG. 13 a flowchart illustrating an example process 1300 for soft relay reselection is shown according to one or more embodiments. The process 1300 is performed by the second relay WTRU. The second relay WTRU is an intermediate end WTRU functioning as an intermediate relay WTRU.

At 1310, the second relay WTRU receives, from a first relay WTRU, the first LMR message indicative of the relay reselection indication and/or a plurality of candidate relay WTRUs accessible by the first end WTRU in direct PC5 connection.

At 1320, the second relay WTRU discovers the one or more one or more candidate relay WTRUs from the plurality of candidate relay WTRUs.

At 1330, the second relay WTRU may transmit, to the candidate relay WTRU from the one or more candidate relay WTRUs, the LER message and/or the second LMR message. The LER message and/or the second LMR message is indicative of an identifier of the first end WTRU, an identifier of the second relay WTRU, and/or a quality of service (QoS) information set between the first end WTRU and the second relay WTRU associated with the downstream peer end WTRUs of the first end WTRU that are routable via the first relay WTRU and the second relay WTRU. In an example, the candidate relay WTRU may establish the security with the second relay WTRU if the PC5 connection between the candidate relay WTRU and the second relay WTRU has not been established.

At 1340, the second relay WTRU receives, from the candidate relay WTRU, the LEA message and/or the second LMA message.

At 1350, the second relay WTRU transmits, to the first end WTRU, via the first relay WTRU, the first LMA message indicative of the relay reselection indication and/or establishment of the second communication link between the first end WTRU and the second relay WTRU.

At 1360, the second relay WTRU receives the LMN message from the first end WTRU via the candidate relay WTRU.

At 1370, the second relay WTRU forwards the LMN message to one or more downstream end WTRUs.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A wireless transmit/receive unit (WTRU) comprising:
a memory;
a transceiver; and
a processor, wherein the transceiver and the processor are configured to:
detect degradation in a first link with a first relay WTRU,
identify one or more candidate relay WTRUs,
transmit, to the first relay WTRU, a first link modification request (LMR) message indicative of at least one of: a relay reselection indication or the one or more candidate relay WTRUs, and
establish a second link with a candidate relay WTRU from the one or more candidate relay WTRUs.

2. The WTRU of claim 1, wherein the transceiver and the processor are further configured to:
receive, from the first relay WTRU, a first link modification accept (LMA) message indicative of at least one of: the relay reselection indication or an acknowledgement of establishment of the second link.

3. The WTRU of claim 2, wherein establishing the second link comprises:
receiving, from the candidate relay WTRU, a link establishment request (LER) message or a second LMR message, and
transmitting a link establishment accept (LEA) message based on the LER message or transmitting a second LMA message based on the second LMR message.

4. The WTRU of claim 1, wherein the first link connects to one or more downstream end WTRUs via the first relay WTRU.

5. The WTRU of claim 4, wherein the transceiver and the processor are further configured to:
transmit, to the one or more downstream end WTRUs, a link modification notification (LMN) message indicative of establishment of the second link.

6. The WTRU of claim 3, wherein the transceiver and the processor are further configured to:
dynamically update, in a unicast routing table in the memory, one or more routes associated with one or more of: one or more downstream end WTRUs or the one or more candidate relay WTRUs.

7. The WTRU of claim 1, wherein the first LMR message is further indicative of one or more of:
one or more identities of one or more downstream end WTRUs routable via the first relay WTRU, or
a quality of service (QoS) information set associated with one or more downstream peer end WTRUs of the WTRU.

8. A method for use in a wireless transmit/receive unit (WTRU), the method comprising:
detecting degradation in a first link with a first relay WTRU;
identifying one or more candidate relay WTRUs;
transmitting, to the first relay WTRU, a first link modification request (LMR) message indicative of at least one of: a relay reselection indication or the one or more candidate relay WTRUs; and
establishing a second link with a candidate relay WTRU from the one or more candidate relay WTRUs.

9. The method of claim 8, the method further comprising:
receiving, from the first relay WTRU, a first link modification accept (LMA) message indicative of at least one of: the relay reselection indication or an acknowledgement of establishment of the second link.

10. The method of claim 8, wherein establishing the second link comprises:
receiving, from the candidate relay WTRU, a link establishment request (LER) message or a second LMR message; and
transmitting a link establishment accept (LEA) message based on the LER message or a second LMA message based on the second LMR message.

11. The method of claim 8, wherein the first link connects to one or more downstream end WTRUs via the first relay WTRU.

12. The method of claim 11, the method further comprising:
transmitting, to the one or more downstream end WTRUs, a link modification notification (LMN) message indicative of establishment of the second link.

13. The method of claim 10, the method further comprising:
dynamically updating, in a unicast routing table, one or more routes associated with one or more of: one or more downstream end WTRUs or the one or more candidate relay WTRUs.

14. The method of claim 8, wherein the first LMR message is further indicative of one or more of:
one or more identities of one or more downstream end WTRUs routable via the first relay WTRU, or
a quality of service (QoS) information set associated with one or more downstream peer end WTRUs of the WTRU.

15. A wireless transmit/receive unit (WTRU) comprising:
a memory;
a transceiver; and
a processor, wherein the transceiver and the processor are configured to:
receive, from a first relay WTRU, a first link modification request (LMR) message indicative of at least one of: a relay reselection indication or a plurality of candidate relay WTRUs accessible by a first end WTRU,
discover one or more candidate relay WTRUs from the plurality of candidate relay WTRUs,
transmit, to a candidate relay WTRU from the one or more candidate relay WTRUs, a link establishment request (LER) message or a second LMR message, and
receive, from the candidate relay WTRU, a link establishment accept (LEA) message based on the LER message or receive a link modification accept (LMA) message based on the second LMR message.

16. The WTRU of claim 15, wherein at least one of: the LER message or the second LMR message is indicative of one or more of:
an identifier of the first end WTRU,
an identifier of the WTRU, or
a quality of service (QoS) information set between the first end WTRU and the WTRU associated with one or more downstream peer end WTRUs of the first end WTRU routable via the first relay WTRU and the WTRU.

17. The WTRU of claim 15, wherein the transceiver and the processor are further configured to:
transmit, to the first end WTRU, via the first relay WTRU, a first LMA message indicative of at least one of: the relay reselection indication or establishment of a second communication link between the first end WTRU and the WTRU.

18. The WTRU of claim 17, wherein the LMA message is a second LMA message.

19. The WTRU of claim 15, wherein the transceiver and the processor are further configured to:
receive a link modification notification (LMN) message from the first end WTRU via the candidate relay WTRU, and
forward the LMN message to one or more downstream end WTRUs.

20. The WTRU of claim 15, wherein the WTRU is an intermediate end WTRU functioning as an intermediate relay WTRU.
